(19) United States
(12) Patent Application Publication
(10) Pub. No.: US 2019/0019250 A1
(43) Pub. Date: Jan. 17, 2019

(54) Method for Making a Loan on Real Property

(71) Applicant: Mark Martinho, Redwood City, CA (US)

(72) Inventor: Mark Martinho, Redwood City, CA (US)

(73) Assignee: Mark Martinho, Redwood City, CA (US)

(21) Appl. No.: 16/033,966

(22) Filed: Jul. 12, 2018

Related U.S. Application Data
(60) Provisional application No. 62/533,026, filed on Jul. 15, 2017.

(51) Int. Cl. G06Q 40/02; G06Q 40/06; G06Q 50/16; G06Q 30/06

(52) U.S. Cl. CPC G06Q 40/025; G06Q 30/0645; G06Q 50/163; G06Q 40/06

(57) ABSTRACT

The present invention relates generally to loans and methods of making loans to real property owners that may not qualify for loans through conventional means for countless reasons, including, but not limited to, lack of adequate income, poor credit, or lack of property management experience. In this present invention, the loan qualifications are based on various parameters, including, but not limited to, the value of the property, its loan to value ratio, and the projected income that can be derived from renting out the real property to meet its debt burden, its operating expenses, and any reserve savings requirements. It is necessary for the present invention that the property is either non-owner occupied, or will soon be non-owner occupied. The present invention further relates to software and systems for practicing the loan method of the invention.

### FIELD OF INVENTION

The present invention relates generally to loans and methods of making loans to real property owners that may not qualify for loans through conventional means for countless reasons, including, but not limited to, lack of adequate income, poor credit, or lack of property management experience. In this present invention, the loan qualifications are based on various parameters, including, but not limited to, the value of the property, its loan to value ratio, and the projected income that can be derived from renting out the real property to meet its debt burden, its operating expenses, and any reserve savings requirements. It is necessary for the present invention that the property is either non-owner occupied, or will soon be non-owner occupied. The present invention further relates to software and systems for practicing the loan method of the invention.

### BACKGROUND

Many people (especially the elderly) have most of their wealth locked up in real estate (typically in the form of their primary residence) and have few other significant assets to sustain everyday living expenses or to withstand the costs of an expensive emergency. Many also lack the requisite income to qualify for a loan against their real property should an event arise requiring a substantial sum of money. This often forces individuals to sell their real property, which frequently results in large capital gains taxes and destroys the owner's opportunity to pass down property to heir(s) or beneficiaries plus removes the benefit to the owner of further appreciation in the property's value.

### Seniors & Reverse Mortgages

A solution for cash-strapped seniors has been to obtain a reverse mortgage on their primary residence. A reverse mortgage is a government secured loan that pays seniors either a lump sum of money or provides the ability to draw on a fixed sum. Reverse mortgages are only available on personal residences where all people on title are 62 years of age or older. The amount loaned on a reverse mortgage is based on borrower's age and the value of their primary residence. The borrower does not have to make mortgage payments, but interest does accrue on the loan until it is fully repaid. A reverse mortgage does not have to be repaid until the borrower either stops living at the property or passes away. Once either of these triggering events occurs, then the reverse mortgage must typically be repaid within 3 to 6 months, depending on the mortgage product and individual lender's requirements.

Often, seniors who have taken out a reverse mortgage unexpectedly reach a point, where for either reasons related to health, security, companionship, or an inability to care for themselves or the property, they must move out of the home they own. The act of vacating their home requires that the reverse mortgage be repaid, but seniors who typically have reverse mortgages do not have the assets to repay the loan unless they sell their home. In these circumstances, the homeowner is often forced to sell their home to repay the loan. Selling a home under these conditions may result in large capital gains taxes. Moreover, while the homeowner may be left with a small nest egg after the mortgage and capital gains taxes are paid off, they have lost the opportunity to receive cash flow from the property, to benefit from future increases in value, or to pass the property on to heir(s) whom may enjoy huge tax advantages from inheriting the property.

### Non-Owner Occupied (or Soon to be Non-Owner Occupied) Real Property

There are also situations where a real property owner (applies to residential or commercial property) whom either does not live on the property or intends to soon vacate it, needs to borrow money using the real property as collateral, but may not qualify for a loan through mainstream sources, such as major banks. The reasons they may be unqualified can include, but are not limited to, poor credit, inadequate income, or a lack of property management experience. Many lending institutions will ignore the rental income real property can produce if the owner does not have previous property management experience. Sometimes such property owners are forced into obtaining “hard money” (non-collateralized) loans that typically cost 2-3 times the interest rate charged by banks to a borrower with good credit and adequate income. The monthly payments on a high interest rate loan may result in negative cash flow. An owner whom cannot afford to carry such a burden may be forced to sell the property, which again could result in a high tax burden, the loss of potential ongoing income, the loss of a future increase in the property's value, and the inability to transfer the property to heir(s) later.

### SUMMARY OF INVENTION

The goal of the present invention is to create reasonably priced loan solutions that will enable real property owners, not served by traditional loan products, to obtain a loan enabling them to continue owning their real property as a rental. These owners may not be able to obtain a conventional loan for a variety of reasons, including, but not limited to, inadequate income, poor credit, or lack of property management experience. The present invention requires that the property owners either do not currently occupy the property or are about to permanently vacate it. In an embodiment, the invention contemplates that an owner will never occupy the property again or that the owner's intent is not to occupy the property for a substantial period. In an embodiment, the owner will not reside at the property until the loan is fully repaid. In the present invention, qualifying for the loan will not be based on parameters like the owner's income, credit, or property management experience. Instead, various other qualification parameters shall be used, including, but not limited to, the ability of the real property to generate sufficient rental income to pay the monthly mortgage plus any other operating expenses associated with owning and renting out the real property, including, but not limited to, property taxes, insurance, maintenance, property management fees, and utilities. Furthermore, in the present invention, the loan amount to property value ratio shall be a factor in determining the interest rate the investor will charge the property owner and that ratio shall never exceed 90%.

In an embodiment of the present invention, the benefits property owners receive from obtaining the loan include, but are not limited to, maintaining ownership of the property, enjoying future value appreciation, potentially receiving cash flow from rent proceeds, potentially receiving a lump sum of cash, avoiding present capital gains taxes, and the ability to pass the property on to heir(s) or beneficiaries. In an embodiment, the lender's investment will be well protected by maintaining conservative loan to property value ratios and by requiring that professional property management services be employed to maintain the property and collect its rental income. This action should result in a borrower obtaining more favorable loan terms for themselves given the reduced risk to the lender's investment and better assurances that the lender will receive timely monthly payments. The lender's risk of losing his funds is reduced because there shall be adequate net equity in the property to fully repay his investment should the property need to be foreclosed on. Furthermore, employing professional property management services shall minimize vacancies, correctly maintain the property, and collect rents is a timely fashion, which may be directly paid to the lender by the property management company.

In various embodiments, the primary tasks involved in the life of the loan, include but are not limited to, qualifying the borrower's property, obtaining funds for the loan, making the necessary repairs to the property, managing the rental property, and servicing the loan. These tasks may all be performed by either the same or affiliated parties/entities or the different primary tasks (or combinations thereof) can be performed by parties/entities that are completely independent of one another.

Herein the real property owner desiring a loan may be referred to as the “client,” “borrower,” “owner,” “seller,” or “applicant.” Where such terms are used for the purpose of seeking a loan, the terms could apply to an individual or multiple people on title to the property. Herein, when referring to the “owner” as deceased, it is implied that the owner was either the sole person on title to the property or was the last remaining living person on title when they died. Herein, the parties/entities that fund the loan will be referred to as the “lender,” “investor,” or the “lender/investor.” In an embodiment, the parties/entities that provide funds for the loan may also be the same parties/entities, or affiliated with the same parties/entities, that are referred to herein as either the “arranger of credit,” the “broker,” or the “loan broker.” In an embodiment, the parties/entities that provide property management services may also be the same parties/entities, or affiliated with the same parties/entities, that are referred to herein as either the “lender,” “investor,” “arranger of credit,” or the “broker.” In an embodiment, the parties/entities that provide loan servicing may also be the same parties/entities, or affiliated with the same parties/entities, that are referred to herein as either the “lender,” “investor,” “arranger of credit,” the “broker,” or the “property manager.” Herein the person(s) whom may inherit the borrower's estate, be they heirs or beneficiaries, shall herein be referred to as “heir(s).”

The loan approval process for the present invention requires several investigations. These investigations include, but are not limited to, the processes enumerated below and are not necessarily completed in the order listed:
(1) physically inspect the property to assess its condition and record its physical attributes like size of structures, lot size, number of rooms, etc.,
(2) perform cost analysis to make the property safe and rentable,
(3) research all existing debts attached to the property,
(4) research property records to determine legal lot size and permitted improvements,
(5) perform a title search to verify client is legally entitled to borrow against the property,
(6) analyze costs related to loan and escrow fees,
(7) analyze local rental market to determine the rental value of the property,
(8) perform a market value analysis of the real property,
(9) calculate a loan to value ratio to assess loan risk,
(10) analyze interest rates offered by major institutions for similar loan size and properties,
(11) calculate an interest rate for the loan based on several risk parameters,
(12) perform a maintenance reserve study for the property, and
(13) perform a cash flow analysis to determine whether the rent will be sufficient to pay the monthly debt, operating expenses, and build up cash reserves.

In an embodiment, aspects of the present invention are implemented on one or more computers executing software instructions. In an embodiment, instructions are loaded into the memory of the server or client computers from a storage device or from one or more other computer systems.

As described in detail herein, the inventive financial product, including its various embodiments, may herein be referred to as a “Real Property Income Based” Loan (RPIB).

### BRIEF DESCRIPTION OF THE FIGURES

The present invention can be more fully understood by reading the following detailed description together with the accompanying drawings, in which like reference indicators are used to designate like elements, in which:

FIG. 1 is a diagram showing a common reverse mortgage scenario whereby the owner must sell his property, resulting in a potential large loss of value to the seller's estate due to taxes.

FIG. 2 is a diagram showing a better result to a reverse mortgage scenario where the wealth of the estate is better preserved for heir(s) through one embodiment of the invention.

FIG. 3 is a diagram showing how an owner that may be unqualified for a loan through conventional means may borrow against his property through one embodiment of the invention.

FIG. 4 is a high-level flowchart showing the RPIB Loan qualification process associated with financing a loan based on the property's loan to value ratio and its ability to generate sufficient cash flow to service the debt and operating expenses for one embodiment of this invention.

FIG. 5 is a flowchart showing further details for performing a title, debt, occupancy status, operating expenses, and a cash out examination regarding the property in accordance with FIG. 4 in one embodiment of this invention.

FIG. 6 is a flowchart showing further details about researching local planning and permit records regarding the lot and structures on the property in accordance with FIG. 4 in one embodiment of this invention.

FIG. 7 is a flowchart showing further details of the broker property assessment in accordance with FIG. 4 in one embodiment of this invention.

FIG. 8 is a flowchart showing further details for performing a rental value analysis and current a resale value analysis for the subject property in accordance with FIG. 4 in one embodiment of this invention.

FIG. 9 is a flowchart showing further details of the professional inspector's property assessment in accordance with FIG. 4 in one embodiment of this invention.

FIG. 10 is a flowchart showing further details of how a repair/upgrade property cost analysis is performed in accordance with FIG. 4 in one embodiment of this invention.

FIG. 11 is a flowchart showing further details of how the monthly operating costs for the property are calculated in accordance with FIG. 4 in one embodiment of this invention.

FIG. 12 is a flowchart showing further details of how the total amount of money that the owner needs to borrow is calculated in accordance with FIG. 4 in one embodiment of this invention.

FIG. 13 is a flowchart showing further details for calculating a loan to value ratio and assessing the loan risk in accordance with FIG. 4 in one embodiment of this invention.

FIG. 14 is a flowchart showing further details of how the interest rate for the loan is calculated in accordance with FIG. 4 in one embodiment of this invention.

FIG. 15 is a flowchart showing further details of how the monthly mortgage bill is calculated in accordance with FIG. 4 in one embodiment of this invention.

FIG. 16 is a flowchart showing further details of how the reserve funds study is calculated in accordance with FIG. 4 in one embodiment of this invention.

FIG. 17 is a flowchart showing further details of how the cash flow analysis for the property is performed in accordance with FIG. 4 in one embodiment of this invention.

FIG. 18 is a flowchart showing further details of the loan process and how the loan funds are distributed in accordance with FIG. 4 in one embodiment of this invention.

FIG. 19 is a flowchart showing further details of how the property will be prepared to become a rental and the process by which it will be rented out in accordance with FIG. 4 in one embodiment of this invention.

FIG. 20 is a flowchart showing further details of how the monthly rental income will be distributed in accordance with FIG. 4 in one embodiment of this invention.

FIG. 21 is a flowchart showing further details of the different events that trigger full repayment of the RPIB loan in accordance with FIG. 4 in one embodiment of this invention.

FIG. 22 is a block diagram showing a network system in accordance with one embodiment of the invention.

FIG. 23 is a block diagram showing further details of the loan administration center of FIG. 22 in accordance with one embodiment of the invention.

### DETAILED DESCRIPTION OF THE INVENTION

Today many real property owners are forced to sell their property because of the absence loan products that enable them to obtain an affordable loan. Most of these property owners are unable to obtain a loan due to either inadequate income, poor credit, lack of property management experience, or for various other reasons.

The elderly are frequently amongst the list of people unable to obtain new loans because the majority of their wealth is locked up in real estate (typically in their primary resident) and they often possess few other significant assets or sufficient income to qualify for a loan. Furthermore, although the elderly sometimes outright own a home worth millions of dollars, they are unable to sustain everyday living expenses or to endure the costs of expensive emergencies. Some of the elderly turn to reverse mortgages to overcome their financial difficulties. A reverse mortgage offers seniors cash that does not need to be repaid until they either move out of their home or they pass away. Often seniors that obtain a reverse mortgage do not fully understand the tax consequences if their property needs to be sold before they pass away. Some seniors overestimate the strength of their health or they suddenly fall ill. Others, underestimate how much longer they will in fact live. Ultimately, many seniors must move out of the home they own due to reasons related to health, security, companionship, or an inability to care for themselves or the property. The act of vacating their home requires that the reverse mortgage be fully repaid within 3-6 months, but seniors who typically have reverse mortgages do not have other significant assets to repay the loan unless they sell their home.

There are also other real property owners that likewise fail to meet standard borrowing guidelines, but nonetheless need cash for various reasons. These can include someone who has either moved out of their own home, recently inherited property, or purchased real property with cash. These owners may then find themselves in desperate need of cash for reasons unrelated to the property or for the express purpose of upgrading the property. However, the majority of lending institutions will not approve a loan for such borrowers due to issues like inadequate income, poor credit, or lack of property management experience. Left without access to affordable capital, some of these real property owners are then forced to sell the property.

By allowing people to continue owning their real property, the property owners will avoid the immediate need to pay large capital gains taxes, they may continue to benefit from additional appreciation in the property's value, they may receive some rental income, and they may have the opportunity to pass the property on to their heir(s) whom could enjoy huge tax advantages from inheriting the property plus experience the emotional gratification of keeping the property in the family.

Embodiments of the present invention create reasonably priced loan solutions that will allow real property owners, that may not be served by traditional loan products due to various reasons, including, but not limited to, inadequate income, lack of property management experience, or poor credit, to obtain a loan that enables them to continue owning their real property without occupying it.

The loan qualifications in the embodiment of the present invention are not be based on a property owner's income, credit score, or property management experience. Loan qualification parameters in the embodiments of the present invention instead include performing an analysis to determine whether renting out the property will generate sufficient cash flow to pay monthly debt obligations, operating expenses, and build up cash reserves while maintaining a conservative loan to value ratio. Where real property, independent of its owner, can qualify for a loan under the guidelines of the present invention, then there is no immediate need to sell the property. The owner may continue enjoying the benefits of ownership, including options of how ultimately to dispose of the property.

Herein, various aspects of the invention will be described related to the use of the innovation by seniors. However, the invention is not limited to seniors, i.e., elderly persons or to reverse mortgages.

In an embodiment, the present invention is specifically designed to enable senior citizens with reverse mortgages on their primary residence to be able to continue owning the property after they have moved out.

A reverse mortgage is a government secured loan that pays out either a lump sum of money or the ability to draw on a fixed sum using a primary residence as collateral. The amount loaned on a reverse mortgage is based on borrower's age (all people on title must be a minimum of 62 years of age) and the value of the owner's residence. The borrower does not have to make mortgage payments, but interest does accrue on the loan until it is fully repaid. A reverse mortgage does not have to be repaid until the borrower either stops living at the property or passes away. Then the reverse mortgage must typically be fully repaid within 3-6 months, depending on the mortgage product and individual lender requirements.

Reverse mortgages by their nature are almost designed to force seniors who must vacate their residence to sell the property to repay the reverse mortgage. The elderly are frequently amongst the list of people unable to obtain new loans because other than their personal residence, they often possess few other significant assets or sufficient income to qualify for a loan to repay a reverse mortgage. If the senior had other significant assets or income, it is unlikely they would have needed a reverse mortgage in the first place. So, when a senior with a reverse mortgage vacates their home, either voluntarily or unexpectedly, that triggers the acceleration clause in the reverse mortgage demanding that the loan be fully repaid within 3-6 months. However, such seniors are typically unable to repay the reverse mortgage unless they sell their home because there are no affordable loan products in the market that will enable such seniors to fully repay the balance owed on their reverse mortgage and continue owning the property.

One embodiment of the present invention specifically offers a solution to seniors with reverse mortgages that either have moved out of their home, or are about to move out, but do not desire to sell the property despite not having the assets to repay the reverse mortgage. In accordance with the embodiments of the invention, the invention provides property owners financing without the typical qualifications of good credit, sufficient income, or property management experience. The core requirements to qualify for the loan in this invention are that the debt does not exceed a specified ratio when compared to the value of the property, that the property is either currently rented or may be put up for rent soon, and that the rent is sufficient to pay for the mortgage payments, operating expenses, and build up reasonable cash reserves.

In an embodiment, the present invention allows a senior with a reverse mortgage to move out of their primary residence and not have to sell their property if they qualify for this innovative loan. While the process of determining whether a property is qualified for the innovative loan is complicated, it is fairly invisible to the client requesting the loan. The client merely allows the broker and inspectors access to the home so the property can be assessed plus grants the broker permission to investigate debts attached to the property. If the property qualifies for a loan, then in one embodiment, the client merely follows an application process simpler than applying for a conventional loan.

The loan qualification process focuses on whether the borrower's property is capable of being rented out for a sufficient amount, such that it can meet the new debt obligation, operating expenses, and build up cash reserves. The property must also have a loan to value ratio low enough for the loan to be considered relatively safe for the lender. If the property meets these qualifications, then the owner is free to vacate their home without having to sell it. The new loan provided by this innovation pays off all debt, including the reverse mortgage, plus it includes funds to update/repair the property to make it safe, desirable to renters, and address future property maintenance issues. With this innovative loan in place and the reverse mortgage fully repaid, the property can be repaired/upgraded so that it may rented out. Once rented, the property will generate the income necessary to sustain itself and potentially even provide the owner some positive cash flow.

Professional property management will also be engaged so that the homeowner is not burdened with managing the rental, which will increase the lender's confidence that their collateral is being well maintained. The property management company will collect rents, pay debts, handle repairs, and potentially pay the mortgage directly to the lender. Having professionals managing the property should mitigate the risk to the lender, which should result in better loan terms for the property owner.

Herein, various aspects of the invention will be described relative to the use of the innovation by real property owners of any legal age whom have not obtained a reverse mortgage.

The identical process used in one embodiment of the invention to assist seniors with reverse mortgages can also be applied to anyone, of any legal age, that owns real property and needs cash, but either lacks sufficient income, good credit, or the property management experience to be able to obtain a conventional loan using the property as collateral. Many lending institutions will ignore the rental income that real property can generate if the owner does not possess previous property management experience. Sometimes real property owners are forced into obtaining “hard money” (non-collateralized) loans that typically cost 2-3 times the interest rate charged by banks to a borrower with good credit and adequate income. A high interest rate loan may result in negative cash flow for a cash-strapped property owner, resulting in the need to sell the property if they are in desperate need of funds. Selling the property could result in a high tax burden, the loss of potential ongoing income, the benefit of a future increase in the property's value, and the inability to transfer the property to heir(s) later.

Again, in this present invention, the property must be able to be rented out or potentially already be a rental property. An analysis of its resale value, rental value, total debts, required loan amount, loan to value ratios, interest rate determination, etc. shall be performed to decide whether the property generates sufficient income to pay the debt plus all the related operating expenses.

Borrowers in need of this present loan innovation could include seniors without reverse mortgages looking to downsize to a smaller home. These seniors may need cash to purchase the smaller home, but do not wish to sell their original house. It could include someone with little income or poor credit whom has inherited a property they wish to rent out, but lack the funds to perform needed repairs/upgrades to the property to make it habitable for a tenant. Another user of the invention could be someone that owns property, but needs money for reasons unrelated to the property (medical issues, kid's college, dream vacation, settle a suit, legal bills, etc.) and again due to poor credit or insufficient income they are unable to obtain a loan through conventional means.

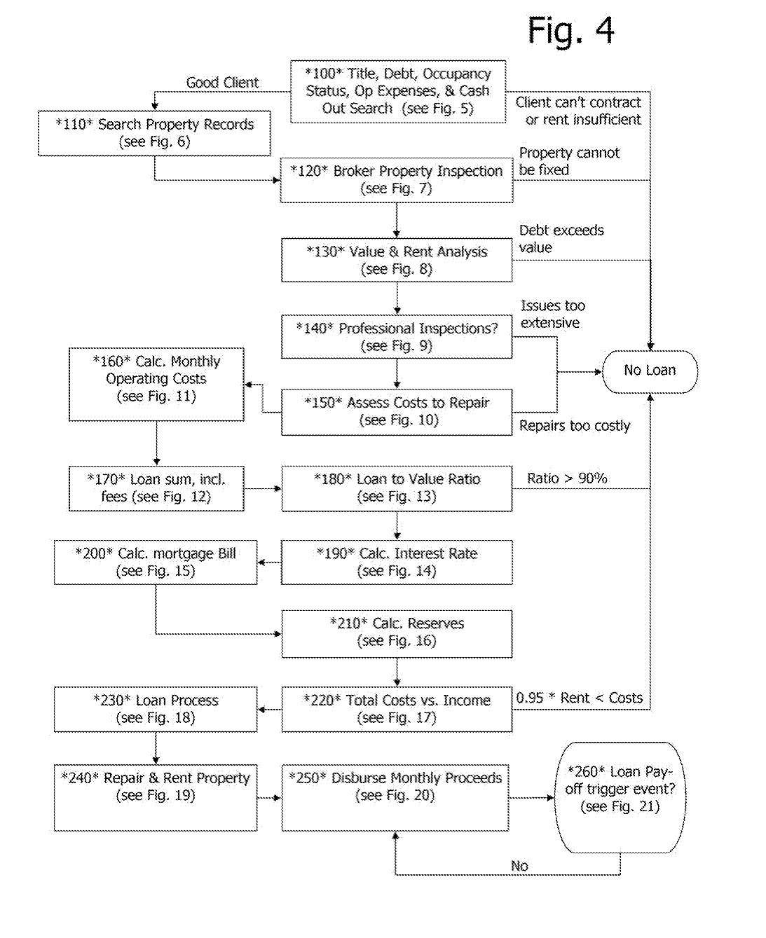

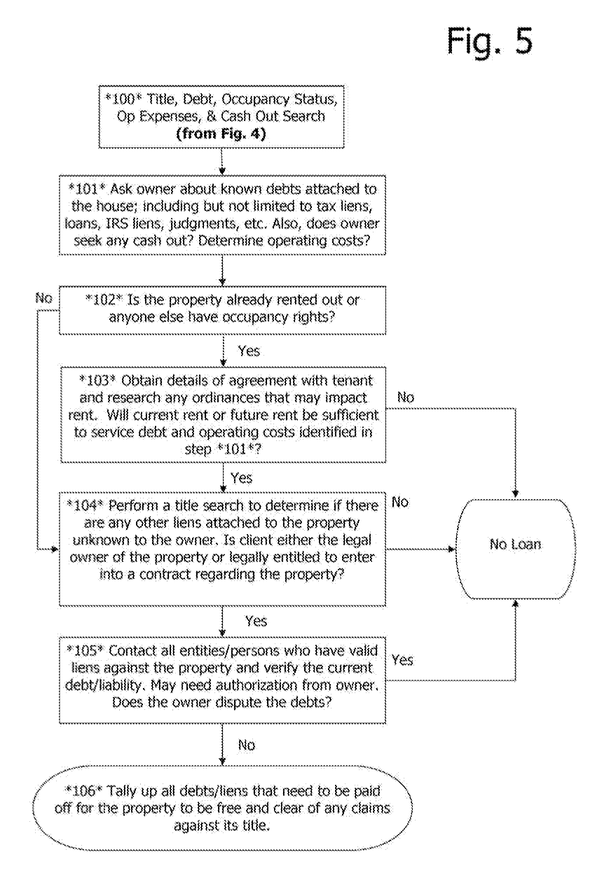

The present invention entails, but is not limited to the following processes and analysis as shown in the high-level flowchart in FIG. 4. A breakdown of these high-level processes is detailed in FIGS. 5-21.

Herein, where a property is referred to as being made “desirable” to potential tenants or “rentable”, it can include, but is not limited to, performing upgrades like painting interiors and exteriors, installing new or refinished flooring, new appliances, better hardscaping, improved landscaping, and kitchen or bathroom remodels.

Herein, where a property is referred to as being made “safe,” it means that the property may require removal of dangerous conditions that can include properly disposing of chemicals or hazardous wastes stored at the property, hiring people to properly remove hazardous building materials that may be laden with asbestos or lead. It can also include eradicating mold issues, repairing structural problems caused by termites or dry rot. An inspection of the gas and electrical appliances will also be performed to determine whether they can be safely operated. Repairing such undesirable or unsafe conditions in a property will mitigate an owner's liability by reducing the likelihood of a tenant being harmed by a dangerous condition at the property.

Herein, where there is a reference to “conditions that could cause further deterioration” of the property, these include items like roofs near the end of their life, poor drainage around the property, or old plumbing. This reference covers any preventative maintenance that needs to be performed before it causes expensive damage to the property. This will herein also be referred to as making the property “robust.”

Herein, where there is a reference to making the property “rentable,” it means taking the actions described in the paragraphs above. This includes, but is not limited to, making the property desirable, safe, and robust for tenants.

FIG. 4., step 100 entails performing a title, debt, occupancy status, operating expenses, and cash out investigation for the property. FIG. 5 breaks down step 100 into steps 101-106.
(1) FIG. 5, step 101 details inquiring from the property owner whether he has any knowledge about debts and/or liens attached to the property that is the subject of the loan? These include bank or personal loans, tax liens, contractor liens, judgments, etc. If the reason for the loan is not purely to retire existing debt or upgrade the property, then any cash out amount the owner seeks needs to be identified. Broker also needs to make inquiries into the operating expenses for the property (whether rented out or not)? These include items like property taxes, property insurance, utilities paid by owner, Home Association fees, or services paid for by the owner (i.e. gardener or pest control). An occupancy assessment also needs to be performed to identify all parties that may have rights to the property.
(2) FIG. 5, step 102 details inquiring from the property owner whether the subject property is currently rented out? If it is not rented out, then skip to step 104.
(3) FIG. 5, step 103 details that if the property is already rented out, then broker shall obtain from the owner the details regarding the agreement with the tenant. Is there a lease? What type of lease? For how long? Are there predetermined rent increases? Are there rent control ordinances in the region which impact the ability to increase the rent or has owner possibly already violated such ordinances? From the information gathered up to this point, if it is obvious that either the current or future rent is insufficient to service the debts and operating expenses revealed in step 101, then the property does not qualify for this innovative financing.
(4) FIG. 5, step 104 details how to verify the presence of recorded liens against the property. First, request a title report from a title/escrow company. This report should include all liens attached to the property and will also state whom is the property's legal owner. If the client requesting the loan is not the legal owner on title and they cannot prove that they have the legal authority to act on behalf of the owner, then the property does not qualify for this innovative financing until the borrower can prove otherwise.
(5) FIG. 5, step 105 details how after all debts and liens attached to the property are identified, the arranger of credit should contact each lien holder and verify the balance owed by the property owner. These balances should all be discussed with the property owner to determine their validity and whether the owner disputes any of them. Where debt disputes exist and the parties cannot come to some compromise, then the property does not qualify for this innovative financing until such disputes are resolved.
(6) FIG. 5, step 106 details how after all the debt information is gathered, then an assessment will be made regarding the cost to retire all debts and liens against the property.

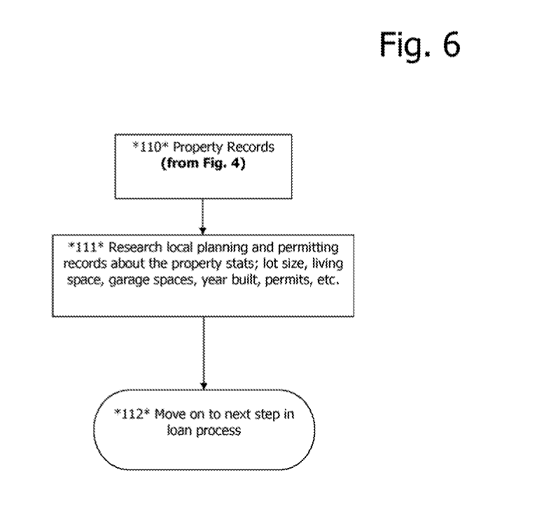

FIG. 4, step 110 entails researching government records regarding the physical description of the property. FIG. 6 breaks down step 110 into more detailed steps 111-112.
(1) FIG. 6, step 111 details investigating local planning/permitting departments to obtain records describing the property and its history. Specifically, characteristics like lot size, size of structures, number of structures, year built, number of bedrooms and bathrooms, commercial spaces, permitted additions, etc.
(2) FIG. 6, step 112 instructs the user to move on to the next step in the loan process after having collected the information in step 111.

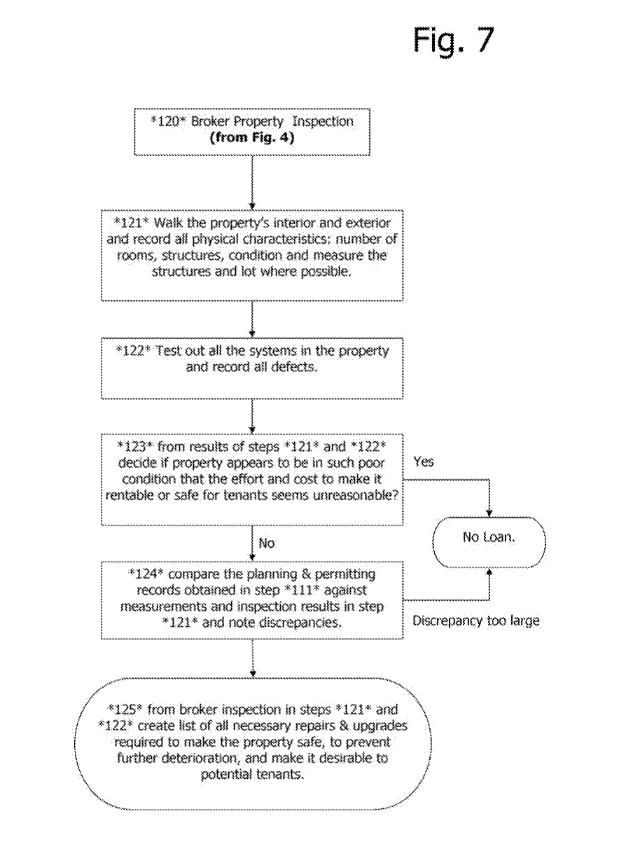

FIG. 4, step 120 entails performing a broker property inspection. FIG. 7 breaks down step 120 into more detailed steps 121-125.
(1) FIG. 7, step 121 details how the broker, or someone hired by the broker, should perform an inspection to record all physical aspects of the property. They should identify and count the total number of bedrooms, bathrooms, other rooms, and other structures on the property. Should this be a commercial property, then identify various commercial spaces by size and function. The visual condition of all parts of the property should also be recorded. The property should also be measured to determine the lot size and the size of all structures.
(2) FIG. 7, step 122 details that the person performing the inspection needs to test the property's systems. This includes actions like turning on all faucets, heaters, coolers, opening and closing doors, garage door openers, trying lights in every room, etc. All defects in any system should be noted.
(3) FIG. 7, step 123 details how the broker should decide from the information collected in steps 121 and 122 whether the property is currently in such poor condition that the cost, time and effort to make the property rentable is economically unreasonable? The broker, or the person hired by the broker to inspect the property, will use their construction experience to make broad determinations regarding the costs and time to make the necessary repairs to the property to make it rentable. If the property cannot be rehabilitated at a reasonable cost and timeframe to make it rentable, then the property will not qualify for this innovative financing.
(4) FIG. 7, step 124 details how the broker should review the physical description of the property (size, number of rooms, etc.) from the inspection in step 121 and compare it to the planning and permit records obtained in step 111. Broker should note any discrepancies that could impact the value of the property, such as permit records describing smaller structures then the structures measured at the property in step 121. Should a substantial discrepancy exist that could considerably negatively impact the value of the property (i.e. no permits were ever issued to build the home on the property), then the property will not qualify for this innovative financing.
(5) FIG. 7, step 125 details how the broker should create a list of all the repairs/upgrades needed to make the property rentable. From the inspection results in steps 121-122 the broker shall list all repairs/upgrades that need to be performed at the property to make it habitable, desirable, safe, and robust. Repairs/upgrades will be organized into their trade types (painting, flooring, roofing, plumbing, etc.).

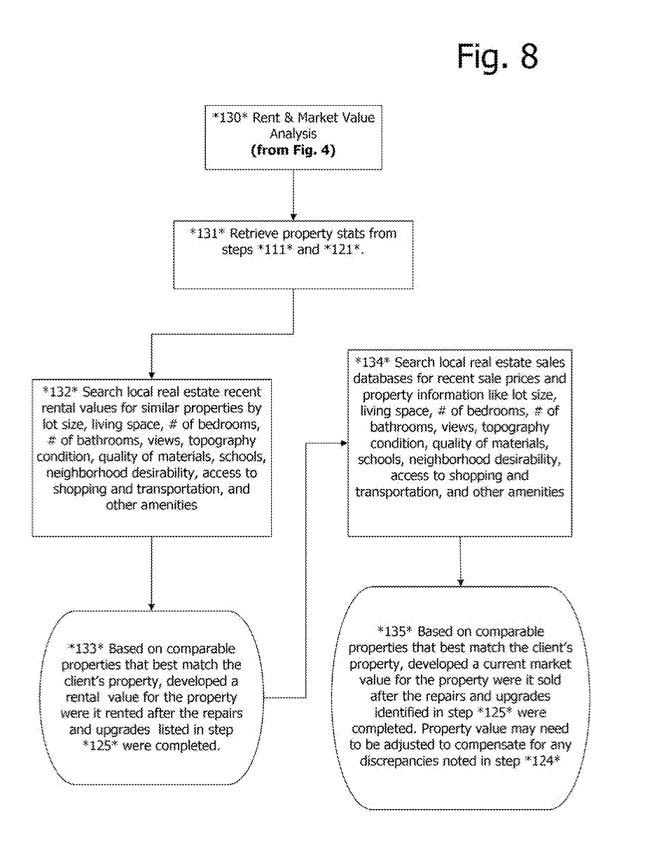

FIG. 4, step 130 entails how a resale value and rent analysis of the property shall be performed assuming the itemized repairs/upgrades in step 125 were completed. FIG. 8 breaks down step 130 into more detailed steps 131-135.
(1) FIG. 8, step 131 entails retrieving the data describing the property from inspections and records in steps 111 and 121.
(2) FIG. 8, step 132 entails searching through real estate databases for comparable properties that were recently rented. Comparisons will include, but will not be limited to, lot and structure size, architecture type, materials used in construction, topography, condition, quality of schools, neighborhood desirability, presence of nuisances (traffic, trains, airports, dumps, etc.), views, and amenities.
(3) FIG. 8, step 133 entails determining the rental value for the property were it rented out in the current market after all the repairs/upgrades listed in step 125 are completed. If the property is already rented it out, perform the rent analysis anyway. The properties most similar to the subject property after it is repaired will be selected from step 132 and value adjustments will be made to compensate for features the subject property possesses, or lacks, as compared to the properties recently rented. Finally, a rental value will be established for the property based on all the data collected.
(4) FIG. 8, step 134 entails searching through real estate databases for comparable properties recently sold in the area. Comparisons will include, but will not be limited to, measured lot size and structure sizes from step 121, lot and structure sizes from step 111, architecture type, materials used in construction, topography, condition, quality of schools, neighborhood desirability, presence of nuisances (traffic, trains, airports, dumps, etc.), views, and amenities.
(5) FIG. 8, step 135 entails deciding a resale value for the property were it sold in the current market after all the repairs/upgrades in step 125 are completed. The properties most similar to the subject property after it is repaired will be selected from step 134 and value adjustments will be made to compensate for features the subject property possesses, or lacks, as compared to the properties recently sold plus any discrepancies between the physical property versus the planning and permit records, as noted in step 124. Finally, a resale value will be established from all the data collected.

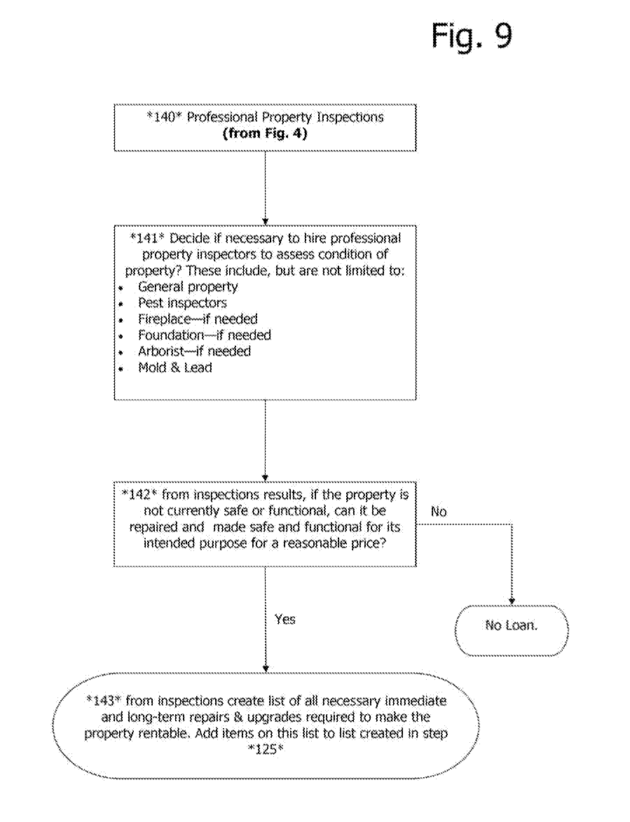

FIG. 4, step 140 entails performing professional property inspections if necessary. FIG. 9 breaks down step 140 into more detailed steps 141-143.
(1) FIG. 9, step 141 details how the broker should hire the appropriate professional inspectors to assess the condition of the property if in the broker's opinion professional inspections are necessary. These could include, but are not limited to a general property inspector, pest inspector, fireplace inspector, foundation inspector, sewer main or septic tank inspection, civil engineers, and arborists. These professionals have skills above and beyond that of the broker and will inspect parts of the property not easily accessible to a broker.
(2) FIG. 9, step 142 details how the broker should review the professional property inspection results to determine whether the property is either currently rentable or can be made rentable for a reasonable cost, time and effort? Even if the property is currently tenant occupied, that does not mean that it is rentable. Obvious or previously unknown conditions could exist that make the property unsafe to occupy. Broker needs to determine if the property needs any immediate repairs beyond those noted in steps 121-122 to make it rentable? Broker also needs to ascertain whether non-immediate repairs should be scheduled to prevent further deterioration of the property. Should the results of the inspections either conclude, or lead to a conclusion, that the property cannot be made rentable, or it is obvious without a full repair price analysis that the costs or time to make the repairs is unreasonable relative to the property value from step 135, then the property does not qualify for this innovative financing.
(3) FIG. 9, step 143 details how after the broker has reviewed all the professional inspection results, the broker shall create a list of all the repairs/upgrades needed to make the property rentable. Repairs/upgrades will be organized into their trade types (painting, flooring, roofing, plumbing, etc.) and items not previously identified in steps 121-122 will be added to the repair/upgrade list created in step 125. A separate list will also be generated regarding repairs that are not judged to be immediately necessary, but should be performed in the future to maintain the property. A schedule regarding when these non-immediate repairs should be performed will also be generated.

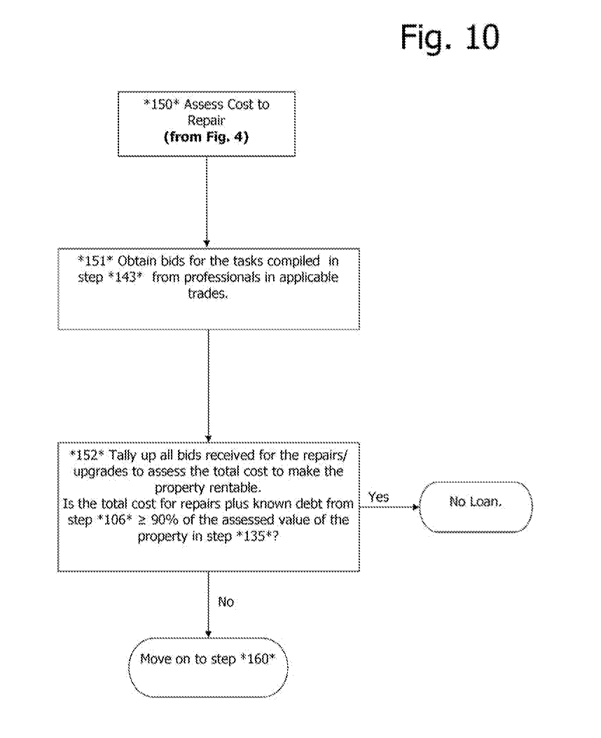

FIG. 4, step 150 entails performing a cost analysis to complete all the repairs and upgrades described in step 143. FIG. 10 breaks down step 150 into more detailed steps 151-152.
(1) FIG. 10, step 151 details how the broker should seek bids from various trades people regarding the different repair/upgrades that need to be performed at the property as recorded in step 143.
(2) FIG. 10, step 152 details how a cost analysis of all the required work should be completed after all bids are received for all repairs/upgrades. Each bid should be reviewed and judged to determine whether it seems reasonable or excessive. Preferably multiple bids will be obtained for items where judging reasonable costs is more uncertain. If the overall tally to complete the immediate repairs/upgrades plus the known debt from step 106 exceeds 90% of the property's estimated resale value from step 135, then the property does not qualify for this innovative financing. If the immediate repair costs from step 152 plus the debt from step 106 is less than 90% of the property's estimated resale value from step 135, then proceed onto the next loan qualification step. In other embodiments of the present innovation, values less than 90% may be applied as the cut off for loan approval.

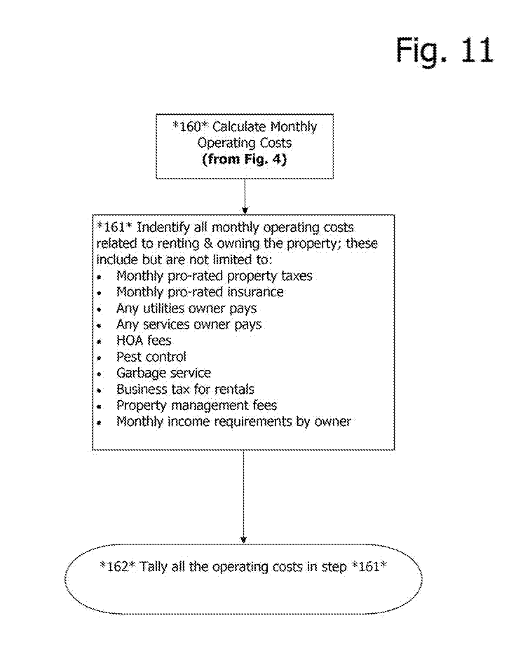

FIG. 4, step 160 in one embodiment entails revisiting and recalculating the total monthly operating costs for the property. FIG. 11 breaks down step 160 into more detailed steps 161-162.
(1) FIG. 11, step 161 describes all the expenses to research for the monthly operating expenses calculation. Operating costs are the costs associated with routine outlays connected with real property ownership, not including the mortgage. These include, but are not limited to, monthly pro-rated property taxes, monthly pro-rated insurance, any utility bill a landlord is responsible to pay, any services a landlord is responsible to pay (i.e. a gardener, garbage service), home owners association fees, pest control, business taxes to own a rental, property management fees, and monthly cash flow requirements by the owner? While operating costs were previously calculated in step 101, these might change as a plan to rent out the property is better refined. Sometimes whether the owner or the tenant is responsible for the cost of a particular service may change; insurance policies may increase as the property transitions to a rental or property taxes may increase due to property upgrades.
(2) FIG. 11, step 162 entails tallying up all the operating expenses identified in step 161 to arrive at an updated monthly operating expenses total.

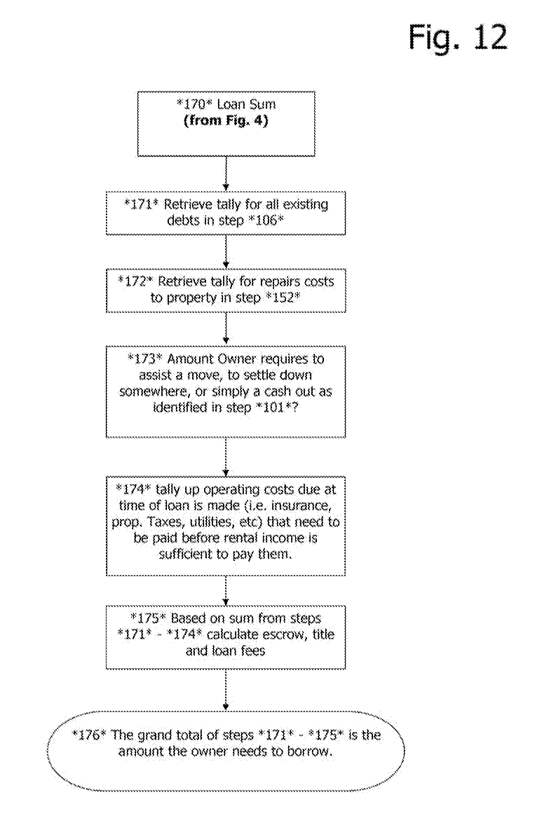

FIG. 4, step 170 entails how the total sum of money the property owner needs to borrow is calculated. FIG. 12 breaks down step 170 into more detailed steps 171-176.
(1) FIG. 12, step 171 retrieves the tally for all existing debts, liens, judgments, etc. attached to the property from step 106.
(2) FIG. 12, step 172 retrieves the tally for the total cost to complete all the required immediate repairs/upgrades to make the property rentable from step 152
(3) FIG. 12, step 173 retrieves the sum for any funds to be paid out to the owner of the property as identified in step 101. These could include funds to resettle or to move the owner to a new home, or simply a cash out for purposes unrelated to this property.
(4) FIG. 12, step 174 retrieves all operating costs for the property from step 162 and calculates the bills that will be due prior to sufficient rent (or any rent at all) being collected to pay these bills. This can include property insurance, property taxes, utility bills, mortgage payments, etc.
(5) FIG. 12, step 175 calculates the escrow, loan, and title fees based on the tally from the amounts from steps 171 through 174.
(6) FIG. 12, step 176 tallies up all amounts in steps 171-175 to determine the total sum of money that the property owner needs to borrow.

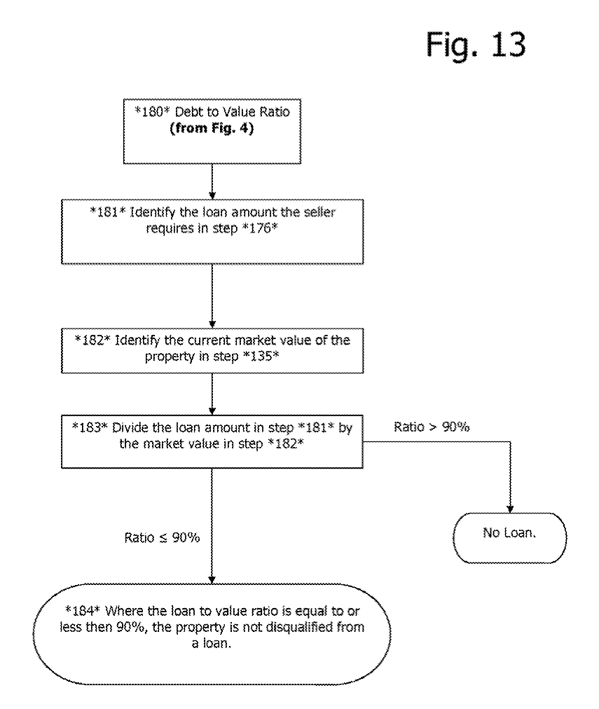

FIG. 4, step 180 entails calculating the loan to value [LTV] ratio. FIG. 13 breaks down step 180 into more detailed steps 181-184.
(1) FIG. 13, step 181 entails retrieving the total loan amount needed by the property owner as tallied in step 176.
(2) FIG. 13, step 182 entails retrieving the resale value of the property from step 135 were the immediate recommended repairs/upgrades completed; as noted in step 125.
(3) FIG. 13, step 183 entails calculating the loan to value ratio. The loan to value ratio is calculated by dividing the loan amount in step 181 by the property's resale value in step 182. Should the LTV ratio be greater than 0.90 (or 90%), then no loan will be made to the property owner. Ideally the ratio will be no greater than 0.75 (or 75%). The 90% ratio limit is subject to be altered anytime where deemed appropriate by broker, but it will continue to be used herein for simplicity purposes.
   The loan to value ratio determines the risk to the lender. The more equity in the property, the safer the investment. Properties with lower LTV ratios allow a lender to foreclose and recuperate their investment more easily should the owner default. A high LTV ratio is riskier for the lender and thus demands a higher loan interest rate.
(4) FIG. 13, step 184 entails that where the resulting ratio is equal to or less then 0.90, then the loan qualification process shall continue forward.

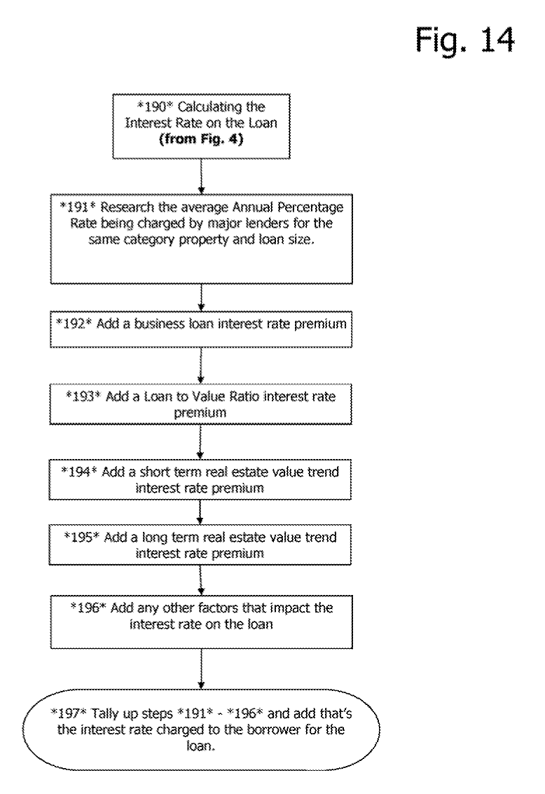

FIG. 4, step 190 entails how the interest rate on the loan is calculated in one embodiment. FIG. 14 breaks down step 190 into more detailed steps 191-197. These steps are merely one method, in one embodiment, by which the final interested rate on the loan may be calculated, but the method could be altered at any time by the broker.
(1) FIG. 14, step 191 in one embodiment entails researching the loan market to estimate the average interest rate charged by major institutions for loans typically applied to the type of property under consideration for the loan. For example, if the property is comprised of a 1-4 unit residential building, then the 30-year, fixed loan rates for single-family homes may be applied for a comparable size loan as the amount from step 176. The interest rate offered by major institutions shall be considered the “base interest rate.” In another embodiment, a loan rate for a different category of property may be used where it is more applicable.
(2) FIG. 14, step 192 recognizes that these are business loans for non-owner occupied properties that need to produce income. Business loans are typically riskier because it is easier for an owner to walk away from a property they do not occupy. Should the value of the property plummet, resulting in zero or negative equity, an absentee owner might decide to default on the loan. For this reason, a business loan premium will be added to the base interest rate. In one embodiment, a 0.5% interest premium or a 1.10 multiplication factor, whichever is greater, is added to the base interest rate estimated in step 191. This business loan interest rate premium is subject to change as loan or real estate market conditions also change.
(3) FIG. 14, step 193 entails adding an LTV ratio premium to the base interest rate. Loans with LTV ratios below 50% are considered extremely safe. LTV ratios in the 50% to 75% range are considered reasonably safe. LTV ratios exceeding 75% are too risky in most embodiments of the present invention, but may nonetheless be considered permissible all the way up to 90% under certain circumstances. The LTV ratio interest rate premium to be added to the base interest rate from step 191 is selected from the list below in one embodiment, but can be altered by the broker at any time:
   a. 0.50% interest where: LTV ratio <50%;
   b. 0.60% interest where: 50%≤LTV ratio <55%;
   c. 0.70% interest where: 55%≤LTV ratio <60%;
   d. 0.80% interest where: 60%≤LTV ratio <65%;
   e. 0.90% interest where: 65%≤LTV ratio <70%;
   f. 1.00% interest where: 70%≤LTV ratio <75%;
   g. 1.25% interest where: 75%≤LTV ratio <80%;
   h. 1.50% interest where: 80%≤LTV ratio <85%;
   i. 2.00% interest where: 85%≤LTV ratio ≤90%;
   j. Property does not qualify for loan where LTV ratio >90%.
(4) FIG. 14, step 194 in one embodiment entails analyzing short-term value trends in the local real estate market. Value trends herein refers to the amount real estate has changed in value over a specified period. The broker will analyze real estate databases to determine the value trend for properties similar to the subject property over the past 12 months. There is always a risk that a declining real estate market could wipe out the equity in the property. The intent in one embodiment is to add a short-term real estate market value trend interest rate [STREMVTIR] premium to the base interest rate from step 191. This premium may be altered anytime by the broker. The short-term real estate market value trend interest rate premium to be added to the base interest rate from step 191 is selected from the list below in one embodiment of this invention:
   a. Value Trend ≥+2.0%: STREMVTIR premium=0.0%
   b. +2.0%>Value Trend ≥−2.0%: STREMVTIR premium=0.15%
   c. −2.0%>Value Trend ≥−5.0%: STREMVTIR premium=0.30%
   d. −5.0%>Value Trend: No loan
(5) FIG. 14, step 195 in one embodiment entails analyzing long-term value trends in the local real estate market. The broker will analyze real estate databases to determine the value trend for properties similar to the subject property over the past 13-36 months. There is always a risk that a declining real estate market could wipe out the equity in the property. The intent in one embodiment is to add a long-term real estate market value trend interest rate [LTREMVTIR] premium to the base interest rate from step 191. This premium can be altered anytime by the broker. The long-term real estate market value trend interest rate premium to be added to the base interest rate from step 191 is selected from the list below in one embodiment of this invention:
   a. Value Trend ≥0.0%: LTREMVTIR premium=0.0%
   b. 0.0%>Value Trend ≥−2.0%: LTREMVTIR premium=0.15%
   c. −2.0%>Value Trend ≥−5.0%: LTREMVTIR premium=0.30%
   d. −5.0%>Value Trend: No loan
(6) FIG. 14, step 196 questions whether any other factors should be considered as a premium to be added from the base interest rate? This could include anything like a rise in building material prices, significant changes in zoning or building codes that could impact real estate prices, local employment trends, populations trends, global economy, interest rate trends, stock market trends, and local housing inventories, etc.
(7) FIG. 14, step 197 entails tallying up the base interest rate in step 191 with the adjustments listed in steps 192-196 to determine the total annual interest rate charged on the loan.

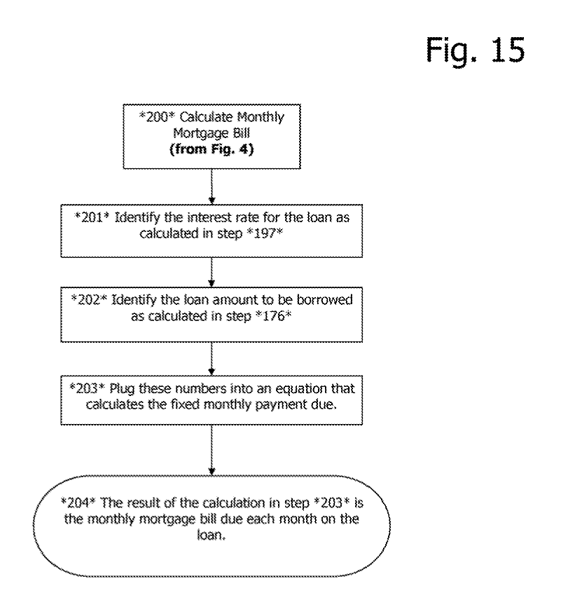

FIG. 4, step 200 entails calculating the monthly mortgage bill owed by the property owner. FIG. 15 breaks down step 200 into more detailed steps 201-204.
(1) FIG. 15, step 201 entails retrieving the interest rate to be charged for the loan from step 197.
(2) FIG. 15, step 202 entails retrieving the loan amount to be borrowed from step 176.
(3) FIG. 15, step 203 entails plugging the interest rate and total loan amount into an equation that calculates the monthly payment to fully pay off the loan in 30 years, in one embodiment. The standard equation used in the United States is as follows:

$$c = \frac{r}{1 - {( 1 + r )}^{- N}} {P}_{0}$$

The variables for this equation are defined as follows:
   ‘c’ is the resulting monthly mortgage payment,
   ‘r’ is the interest rate from step 197 divided by 1,200,
   ‘N’ is the number of monthly payments over the life of the loan (360 in the 30-year loan embodiment), and
   ‘P₀’ is the amount borrowed as identified in step 176,
(4) FIG. 15, step 204 states that the resulting calculation from step 203 is the mortgage payment due each month.

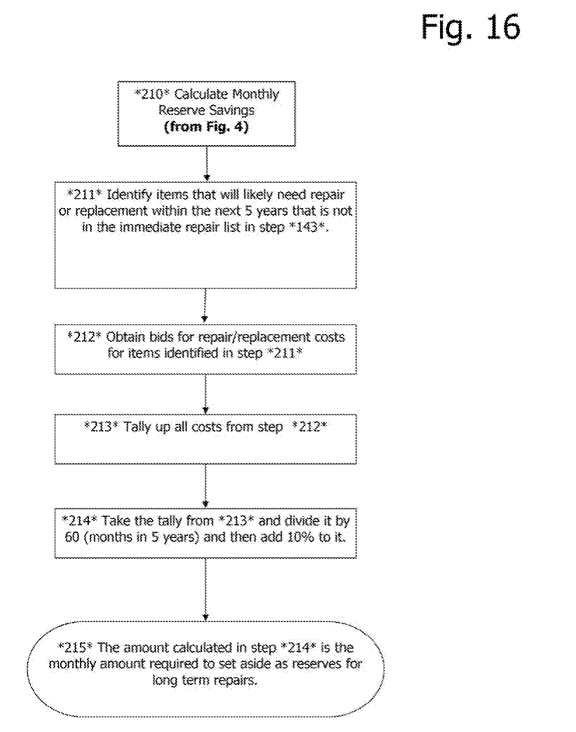

FIG. 4, step 210 in one embodiment entails calculating the amount of reserves required to deal with longer term maintenance issues that will likely come up within the next 5 years as identified in step 143. In other embodiments, this time frame might be altered to reflect the probable life of the loan. FIG. 16 breaks down step 210 into more detailed steps 211-215.
(1) FIG. 16, step 211 entails the broker reviewing the long-term repair/upgrade list generated in step 143 and determining what items will likely need to be replaced/repaired within the next 5 years, which are not scheduled for immediate repair/upgrades?
(2) FIG. 16, step 212 entails obtaining bids from trades people for the costs related to the 5-year repair/replace list generated from step 211.
(3) FIG. 16, step 213 entails tallying up all the bids from step 212
(4) FIG. 16, step 214 entails multiplying the tally from step 213 by 1.1 (a 10% factor for unanticipated cost overruns) and then dividing that result by 60 to calculate the monthly pro-rated savings required during the next 5-years to pay for these repairs/upgrades.
(5) FIG. 16, step 215 identifies the resulting dollar amount from step 214 as the amount of money that needs to be saved each month to meet the reserves required to pay for repairs/replacement of the items identified in step 211.

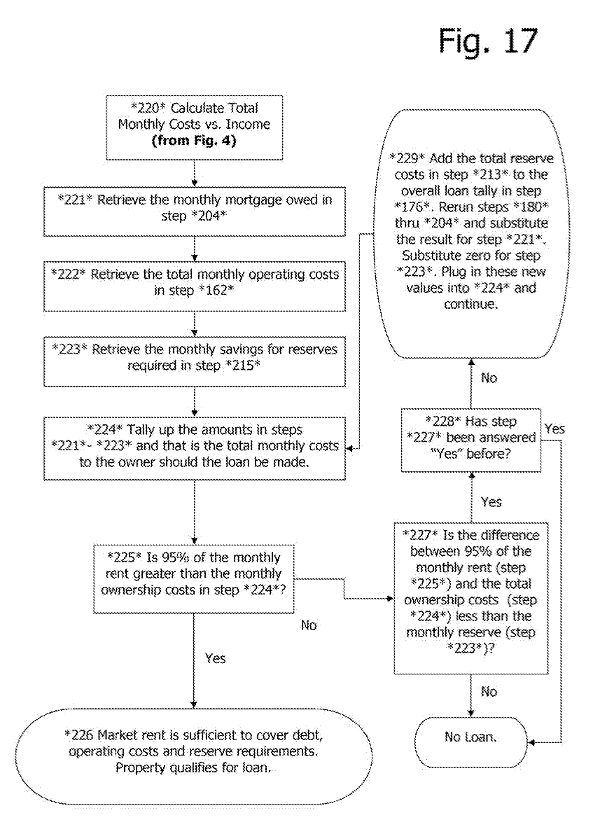

FIG. 4, step 220 entails performing a cash flow analysis by comparing the total monthly costs (mortgage, operating expenses, and reserves) versus the potential income generated from the rent calculated in step 133 to determine whether the property is economically self-sustaining. FIG. 17 breaks down step 220 into more detailed steps 221-229.
(1) FIG. 17, step 221 entails retrieving the monthly mortgage payment calculated in step 204.
(2) FIG. 17, step 222 entails retrieving the total monthly operating costs calculated in step 162.
(3) FIG. 17, step 223 entails retrieving the total monthly reserve savings in step 215.
(4) FIG. 17, step 224, entails tallying up the amounts in steps 221-223. This sum is the total monthly ownership costs for the property should the loan be offered to the property owner.

Herein, this sum shall be referred to as the “monthly ownership costs.”
(5) FIG. 17, step 225 entails comparing the total monthly ownership costs in step 224 to the pro-forma monthly income. Pro-forma monthly income shall be either the monthly rent identified in step 133 or the rent currently paid by an existing tenant, multiplied by 0.95 (a vacancy factor). If the pro-forma monthly income is equal to or greater than the monthly ownership costs in step 224, then the qualification process moves to step 226, which results in the loan being approved. Otherwise the qualification process moves to step 227.
(6) FIG. 17, step 226 entails moving forward in the loan process.
(7) FIG. 17, step 227 determines whether there is a possibility for loan approval if the total reserves required in step 213 were added to the loan instead of accruing monthly from the rent proceeds.
   a. If the shortfall between the pro-forma monthly income and the monthly ownership costs is less than the monthly reserve requirements in step 215, then move on to step 228 in the qualification process.
   b. If the shortfall between the pro-forma monthly income and the monthly ownership costs is equal or greater than the monthly reserve requirements in step 215, then the property does not qualify for a loan.
(8) FIG. 17, step 228 dictates that this re-qualification path may only be performed once. If step 228 has not been answered “Yes” before, then move forward to step 229; otherwise the property does not qualify for this innovative loan.
(9) FIG. 17, step 229 is part of a requalification process that removes the monthly reserves contribution amount from the process and instead adds the total reserves amount from step 213 to the loan tally in step 176. Then steps 180-204 are performed again using the new loan amount to arrive at a new monthly mortgage payment assuming the property in not disqualified while rerunning these steps again. Repeat step 224 using the new monthly mortgage payment in place of the old one for step 221, keep the original amount from step 222, and plug in zero for the amount from step 223. If the pro-form monthly income from step 225 is not greater than the new monthly ownership costs from step 224, then this property does not qualify for the innovative loan. If the monthly pro-forma income from step 225 is greater than the new monthly ownership costs from step 224, then the loan is approved and the process moves on to step 230.

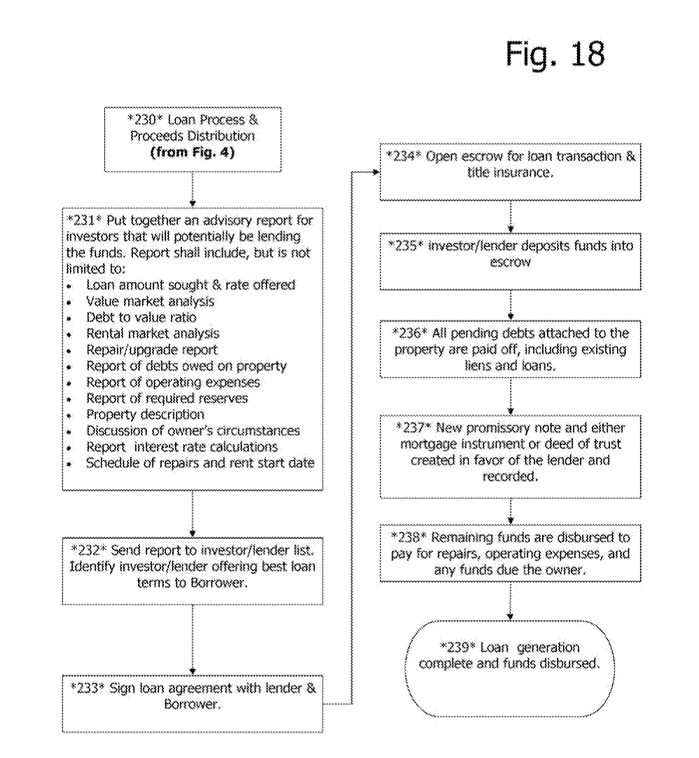

FIG. 4, step 230 in one embodiment describes the loan process after approval has been obtained and how the loan funds are to be disbursed. FIG. 18 breaks down step 230 into more detailed steps 231-239.
(1) FIG. 18, step 231 in one embodiment entails putting together an advisory report for investors regarding the loan. The report shall include, but is not limited to the following information: description and location of the property, loan amount sought, interest rate offered and how it was calculated, resale value analysis of the property after the repairs/upgrades are completed, rental value analysis of the property after the repairs/upgrades are completed, list of planned repairs/upgrades to the property, list of all debts and liens attached to the property, list of anticipated operating expenses, reserve study report and repair schedule, and a discussion of the property owner's circumstances.
(2) FIG. 18, step 232 in one embodiment entails distributing the report to investors from which at least one will be selected to become the lender for the property. There may be further negotiations with the investors to obtain the best loan terms for the property owner. In another embodiment, the broker and lender may either be the same party/entity or affiliated with each other.
(3) FIG. 18, step 233 in one embodiment entails selecting an investor (which could be the broker in some embodiments) and having the investor and property owner sign binding agreements. The agreement will specify how the loan funds will be disbursed through escrow.
(4) FIG. 18, step 234 in one embodiment entails the process of opening escrow to manage the transaction and provide title insurance to the lender(s).
(5) FIG. 18, step 235 in one embodiment entails the lender(s) depositing the loan funds into escrow.
(6) FIG. 18, step 236 in one embodiment entails escrow paying off all debts attached to the property, including liens, loans, and judgments.
(7) FIG. 18, step 237 in one embodiment entails escrow creating a promissory note in favor of the lender(s) plus a foreclosure instrument such as either a deed of trust or mortgage; whichever is custom in the area. Escrow shall record these documents in the county office where the property is located.
(8) FIG. 18, step 238 in one embodiment entails escrow distributing the remaining funds for their intended purpose. These include, but are not limited to, funds for the repairs/upgrades, reserve or operating funds deposited into a trust account, any funds owed to the property owner, fees paid to arrange the credit, fees paid to escrow for their services and title insurance, and any other payments owed at the time escrow closes.
(9) FIG. 18, step 239 completes the loan process and distribution of the loan funds.

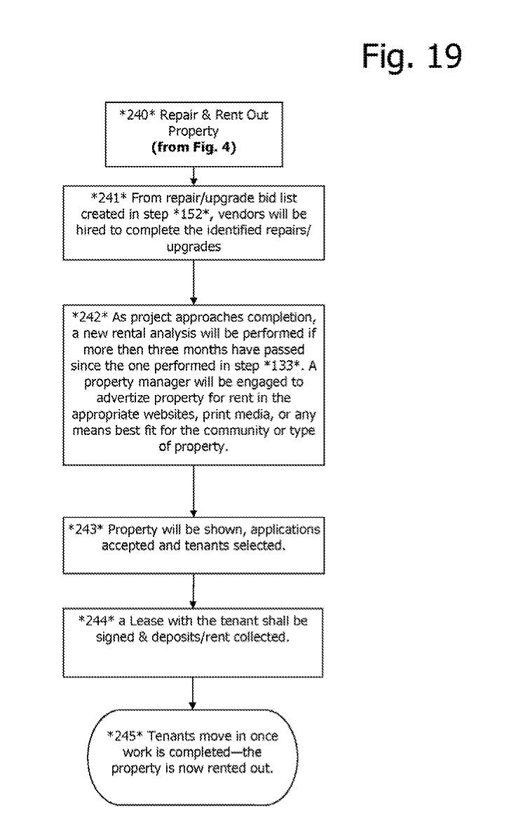

FIG. 4, step 240 in one embodiment entails the process performing the repairs/upgrades to the property and renting it out. FIG. 19 breaks down step 240 into more detailed steps 241-245.
(1) FIG. 19, step 241 in one embodiment entails the broker or property manager reviewing the short-term repair/upgrade bids from step 152 and hiring the trades people to complete the tasks.
(2) FIG. 19, step 242 in one embodiment entails engaging professional property services to advertise the property for rent as the repairs/upgrades near completion to minimize the time the property remains vacant. The property will be advertised in appropriate websites, print media, or any other means that best generates satisfactory results. If more than three months have passed since the rent analysis in step 133 was performed, then run a new analysis.
(3) FIG. 19, step 243 in one embodiment entails engaging the property manager to show the property to potential tenants, accept rent applications, and selecting the best qualified applicant.
(4) FIG. 19, step 244 in one embodiment entails signing a lease between the property manager and the tenant plus collecting deposits and rent from the tenant.
(5) FIG. 19, step 245 in one embodiment entails giving the tenant the keys and allowing them to move into the property after all work has been completed and move-in inspections are performed.

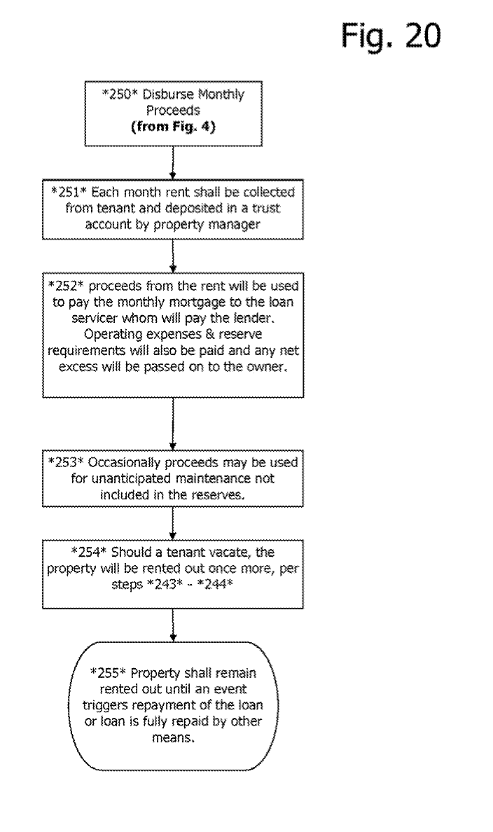

FIG. 4, step 250 in one embodiment entails the process of distributing the monthly rental income. FIG. 20 breaks down step 250 into more detailed steps 251-255.
(1) FIG. 20, step 251 in one embodiment entails the property manager collecting the rent from the tenant each month and depositing it into a trust account.
(2) FIG. 20, step 252 in one embodiment entails the property manager taking part of the rent to pay the loan servicer whom in turn will pay the lender the monthly mortgage. The property manager will also pay the operating expenses, put aside monthly funds for reserve requirements, and send any excess funds to the property owner.
(3) FIG. 20, step 253 in one embodiment entails the need to occasionally spend more than the scheduled maintenance budget on unexpected repairs.
(4) FIG. 20, step 254 in one embodiment entails keeping the property rented out should a tenant vacate. This may require paying to have the property cleaned and painted between tenants.
(5) FIG. 20, step 255 in one embodiment entails repeating steps 251-254 until a triggering event, as defined in step 260, occurs that requires the loan be fully repaid prior to the maturity date.

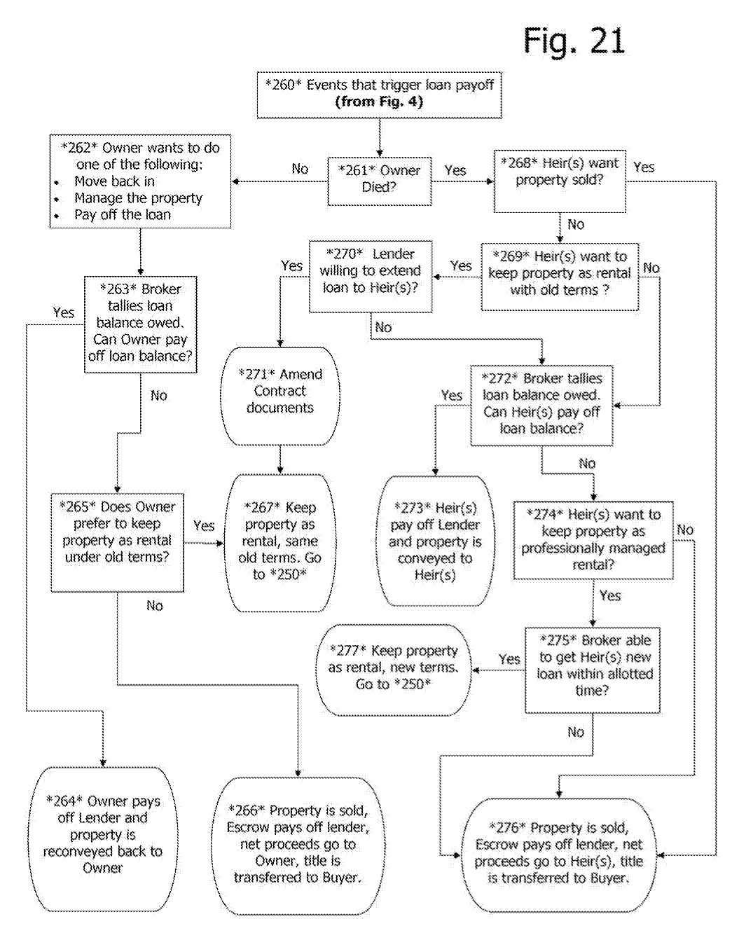

FIG. 4, step 260 in one embodiment details events that trigger repayment of the full loan balance because the owner either wants to alter the terms of the loan agreement or they have died. Should owner have died, then different embodiments may alter the number of days the heir(s) have to fully repay the loan balance owed. FIG. 21 breaks down step 260 into more detailed steps 261-277.
(1) FIG. 21, step 261 inquires whether the property owner has died? If the owner is alive then proceed to step 262 to determine if the owner desires to take any actions that could trigger the loan payoff acceleration clause in the loan agreement. If the owner is dead, then proceed to step 268 to establish what the heir(s) intend to do with the property.
(2) FIG. 21, step 262 lists several actions the owner could desire to take that will trigger the loan payoff acceleration clause in the loan agreement.
   a. In one embodiment, the loan may be fully repaid prior to its maturity date if the owner desires to retire the debt early.
   b. In one embodiment, if the owner wants to move back into the property, then the loan must first be fully repaid. The loan in this present invention is a business loan, it is meant to finance rental property and not owner-occupied property. Furthermore, tenant leases may need to expire or legal notices may need to be given to tenants prior to the property being made vacant for owner.
   c. In one embodiment, the loan must first be fully repaid if the owner wants to manage the rental property themselves. In one embodiment in this present invention, the agreement between the lender and the owner requires that the property shall be professionally managed thus management by the owner violates the terms of the loan agreement.
(3) FIG. 21, step 263 examines whether the owner can afford to fully repay the balance owed on the loan.
   a. The broker shall calculate the loan balance owed by computing the debt still owed minus any reserves collected and not yet spent on the property. Other fees may also apply to the balance owed.
   b. Owner can either pay off the full loan balance by refinancing the debt with another lender or they can pay it off with a cash equivalent (typically a cashier's check or bank wire).
      i. If the owner has the means to pay off the debt, then move on to step 264 in this process.
      ii. If the owner cannot fully repay the loan balance owed, then move onto step 265.
(4) FIG. 21, step 264 details standard escrow procedures for reconveyance and loan pay off. Escrow shall collect the funds calculated in step 263 from the owner or the owner's lender and a reconveyance shall be filed and recorded. All agreements between the owner, lender, property manager, and broker shall be terminated. Owner shall be responsible for dealing with any existing tenants residing at the property at the time such agreements are terminated.
(5) FIG. 21, step 265 examines the owner's options if they cannot afford to pay off the loan balance owed. Here, the owner has the option of either selling the property (move onto step 266) or they can stay with the original arrangement and keep property as rental under the old terms (step 267).
(6) FIG. 21, step 266 details that the property shall be sold to repay the balance owed on the loan.
   a. In one embodiment, a real estate broker shall be hired by the property manager or loan broker to sell the property. The property shall be marketed through standard real estate marketing channels. In an embodiment, the real estate broker may be independent of the loan broker or property manager, but in other embodiments the real estate broker could be part of the same entity or affiliated with the loan broker and/or property manager.
   b. When a satisfactory purchase offer is ratified by the owner of the property, then escrow shall be opened. The buyer and/or the buyer's lender shall eventually transfer the purchase funds to the escrow holder. Title to the property shall then be transferred to the buyer(s). From the sale proceeds, escrow shall pay off the lender (the loan balance owed and other associated fees and taxes), the real estate brokers, and distributed any remaining funds to the owner.
(7) FIG. 21, step 267 states that where the owner cannot afford to repay the loan balance, they have the option of keeping the property as a rental under the original loan terms (process returns to step 250).
(8) FIG. 21, step 268 in one embodiment entails what happens to the property when the owner dies? The owner's death triggers a loan payoff acceleration clause in the loan agreement. Here the heir(s) can either decide to:
   a. sell the property so that the loan balance is fully repaid within 180 days from the time of the owner's death (move onto step 276), or
   b. try to keep the property for themselves (move on to step 269).
(9) FIG. 21, step 269 examines what the heir(s) want to do with the property and how it affects the existing loan:
   a. If the heir(s) intend to move into the property as a personal residence or want to keep it as a rental and property manage it themselves, then the loan must be fully repaid within 180 days from the time of the owner's death and prior to the heir(s) either moving in or assuming management of the property (move onto step 272).
   b. If the heir(s) desire to keep the property as a rental under the same terms as the deceased owner, then the lender will be contacted (move onto step 270) to determine if they are willing to allow the heir(s) to assume the loan.
(10) FIG. 21, step 270 determines whether the lender will allow the heir(s) to assume the decedent's loan under the same terms?
   a. If the lender allows it, then move onto step 271.
   b. If the lender will not allow the loan to be assumed by the heir(s), then in one embodiment the loan must be fully repaid within 180 days from the owner's death (move onto step 272).
(11) FIG. 21, step 271 explains the actions to be performed should the loan be assumed by the heir(s) per step 270. If the lender allows the heir(s) to assume the debt, then a new promissory note and deed of trust (or mortgage) documents will be created and recorded to reflect the new owner's of record. The process then moves onto step 267 where the heir(s) take the place of the decedent owner as the new owners, borrowers, and landlords. They remain under this status in step 250 until a triggering event occurs that either forces the loan to be fully repaid or the heir(s) have fully repaid the loan.
(12) FIG. 21, step 272 examines whether the heir(s) can afford to fully repay the balance owed on the loan.
   a. The broker shall calculate the loan balance owed by computing the debt still owed minus any reserves collected and not yet spent on the property. Other fees may also apply to the balance owed.
      i. If the heir(s) have the means to pay off the debt within the allotted time, then move onto step 273 in this process.
      ii. If the heir(s) cannot fully repay the loan balance owed within the allotted time, then move onto step 274.
(13) FIG. 21, step 273 details standard escrow procedures for reconveyance and loan pay off. Escrow shall collect the funds calculated in step 272 from the heir(s) or the heir(s)’ lender and a reconveyance shall be filed and recorded. Title may also have to be officially transferred from the decedent to the heir'(s) names. All agreements between the owner, lender, property manager and broker shall be terminated. Heir(s) shall be responsible for dealing with any existing tenants residing at the property at the time the agreements are terminated.
(14) FIG. 21, step 274 details that should the heir(s) be unable to repay the loan and the lender is unwilling to allow the heir(s) to assume the decedent owner's loan, then there are two potential outcomes:
   a. If heir(s) intend on taking actions contrary to the prior agreement (intent to occupy the property or manage it themselves as a rental), then the property must be sold to repay the existing loan per step 276.
   b. If heir(s) desire to keep the property as a professionally managed rental, then heir(s) may reapply for a new loan through the broker as outlined in step 275.
(15) FIG. 21, step 275 in one embodiment examines the heir(s) options should they desire to keep the property as a professionally managed rental, but the existing lender will not transfer the decedent's loan to the heir(s).
   a. Broker may attempt to obtain a new loan for heir(s) either through a new lender or the same lender enabling heir(s) to keep the property. The entire loan process will be repeated for the heir(s) except for steps 110, 120, 140, and 150, which should remain unchanged). Should broker be successful in obtaining heir(s) a new loan, then move on to step 277.
   b. Should broker be unable to obtain a new loan for the heir(s) and heir(s) are unable to pay off lender, then the property shall be sold. Move onto step 276.
(16) FIG. 21, step 276 details that the property shall be sold to repay the balance owed on the loan.
   a. In one embodiment, a real estate broker shall be hired by the property manager or loan broker to sell the property. The property shall be marketed through standard real estate marketing channels. In an embodiment, the real estate broker may be independent of the loan broker or property manager, but in other embodiments the real estate broker could be part of the same entity or affiliated with the loan broker and/or property manager.
   b. When a satisfactory purchase offer is ratified by the heir(s) or other legally authorized representative for the property, then escrow shall be opened. The buyer and/or the buyer's lender shall eventually transfer the purchase funds to the escrow holder. Title to the property shall then be transferred to the buyer(s). From the sale proceeds, escrow shall pay the lender (the loan balance owed and other associated fees and taxes), the real estate brokers, and distributed any remaining funds to the heir(s) or estate as legally required.
(17) FIG. 21, step 277 details in one embodiment how the heir(s) become the new owners, borrowers, and landlords. The heir(s) will then remain in step 250 until a triggering event occurs that either forces the loan to be fully repaid or the heir(s) have fully repaid the loan.

Aspects of the present invention may be implemented on one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, or any other similar type of computing device.

In a network embodiment of the present invention, the broker's computer may be configured to access computers either operated by third parties or affiliated parties located off-site. These could include, but not be limited to, lenders, loan underwriters, funders, closers, settlement service vendors, escrow and title services, and other similar loan fulfillment parties through a web based interface that is integrated with a loan origination software program. The loan origination and processing software provides an interface to those companies that will ultimately perform the loan services and provide the requested funds. During the loan application process, various items of information are transmitted among the parties, including borrower information and loan application data. This information is typically maintained in databases stored in the broker computer, or on the third-party computers. Different entities may be responsible for various aspects of the transaction from the lender's side. For example, one company may be involved in the processing of a loan application, while another is involved with providing the loan itself, while yet another may be involved with the billing and collection of repayment from the borrower.

The invention will be better understood from the examples that follow. However, one skilled in the art will readily appreciate that the specific methods and results discussed are merely illustrative of the invention as described more fully in the claims that follow thereafter.

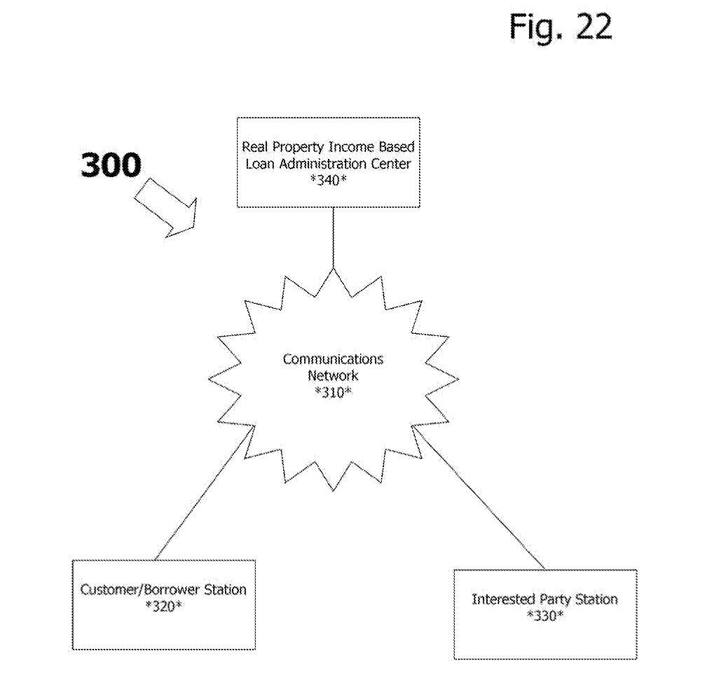

FIG. 22 illustrates one embodiment of a Real Property Income Based Loan system 300 for generating and managing Real Property Income Based Loans, according to various embodiments of the systems and methods described herein. System 300 may include a Real Property Income Based Loan administration center 340, a customer station 320, and an interested party station 330. The Real Property Income Based Loan administration center 340, a customer station 320, and the interested party station 330 may all be connected through communications network 310.

The Real Property Income Based Loan administration center 340 may comprise the processing station or center of an issuer of a Real Property Income Based Loan, such as an insurance company, bank, brokerage firm, or other financial institution, for example. The customer station 320 may comprise the terminal or access point for a borrower. The interested party station 330 may comprise the terminal or access point for other parties who have an interest in the Real Property Income Based Loan, such as owners, purchasers, lenders, investors, consumers, or beneficiaries, for example. Communications network 310 interconnects Real Property Income Based Loan administration center 340, the customer station 320, and the interested party station 330 to enable communication and transfer of data and information. Each is described in more detail below.

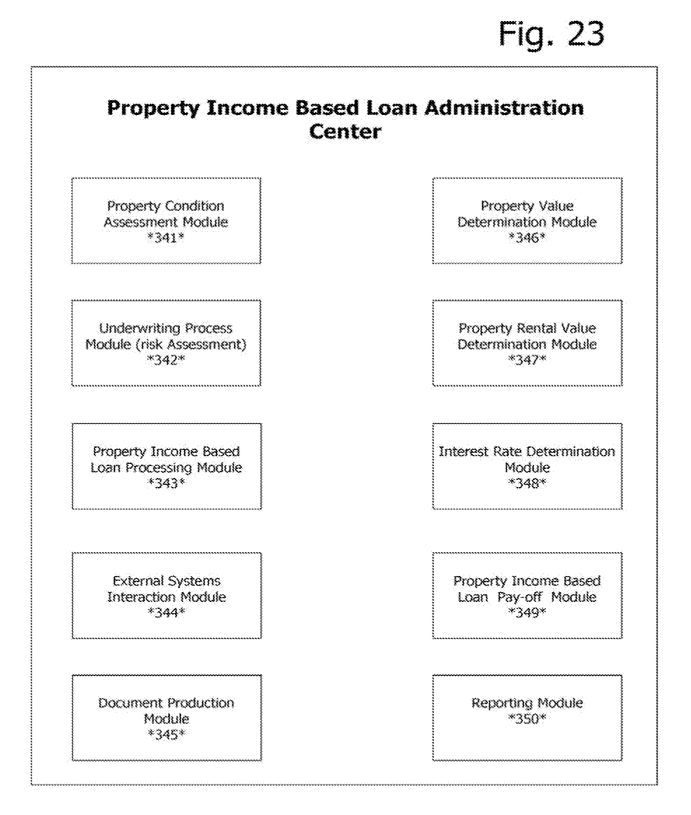

Real Property Income Based Loan administration center 340 may comprise a single server or engine. In some embodiments, Real Property Income Based Loan administration center 340 may comprise a plurality of servers or engines, dedicated or otherwise, which may further host modules for performing the various system functionality described herein. Real Property Income Based Loan administration center 340, for example, may host one or more applications or modules that function to permit interaction between the users (e.g., borrowers, financial institutions, underwriters, and other parties) as it relates to the issuing and administration, for example, of Real Property Income Based Loans as set forth herein. For instance, the Real Property Income Based Loan administration center 340 may include an administration module that serves to permit interaction between the system and the individual(s) or entity(ies) charged with administering the Real Property Income Based Loan administration center 340. Real Property Income Based Loan administration center 340 may further include module(s) for, among other things, assessing Real Property Income Based Loan particulars, such as underwriting particulars, for example. Other modules may permit various manipulations of data (and access to such manipulated data) including, for example, property values, rental values, repairs costs, property descriptions, debt values, names on title, due dates if applicable, payment amounts, equity amounts, and other data or information utilized in the issuing and management of the Real Property Income Based Loan as described herein. FIG. 23 shows exemplary modules that may be associated with the Real Property Income Based Loan administration center.

Real Property Income Based Loan administration center 340 may include, for instance, a Workstation or Workstations running the various versions of Microsoft Windows™ operating systems, the Unix operating system, the Linux operating system, the Xenix operating system, the IBM AIX™ operating system, the Hewlett-Packard UX™ operating system, the Novell Net Ware™ operating system, the Sun Microsystems Solaris™ operating system, the OS/2™ operating system, the BeOS™ operating system, the Macintosh operating system, an Android based operating system, the Apache operating system, an OpenStep™ operating system or another operating system or platform. Real Property Income Based Loan administration center 340 may be operated and maintained by a financial institution, and any affiliates of the financial institution, to issue Real Property Income Based Loans, effect payments, and terminate Real Property Income Based Loans, for example.

Customer station 320 may be used by a customer (e. g. the borrower), for example to interface with the Real Property Income Based Loan administration center 340 and input (or retrieve) information or data in connection with securing or maintaining a Real Property Income Based Loan, for example. In one embodiment, for example, a borrower may interface with a graphical user interface (or GUI), for example, to input data and information through a predetermined form that queries for desired particulars on their particular Real Property Income Based Loan, such as loan amount desired, terms of the financing, expected loan close date, expected loan retirement date, expected monthly cash payout to borrower, and associated costs and fees.

The interested party station 330 provides an interface to interested parties (other than the borrower) in a manner similar to the customer station 320.

The stations 320 and 330 may comprise or include, for instance, a personal computer, a laptop computer, a computer tablet, or a smart phone. These stations may be running a version of Microsoft Windows™ operating system, a Unix™ operating system, a Linux™ operating system, a Solaris™ operating system, an OS/2™ operating system, a BeOS™ operating system, a MacOS™ operating system, an Android™ based operating system, a VAX VMS operating system, or other operating system or platform. The stations 320 and 330 may include a microprocessor such as an Intel based or Advanced Micro Devices device, a Motorola or PowerPC™ device, a MIPS device, Hewlett-Packard device, or a Digital Equipment Corp. RISC processor, a microcontroller or other general or special purpose device operating under programmed control. The stations 320 and 330 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. The stations 320 and 330 may be equipped with an integral or connectable cathode ray tube (CRT), a liquid crystal display (LCD), electro-luminescent display, a light emit ting diode (LED) or another display screen, panel or device for viewing and manipulating files, data and other resources, for instance using a graphical user interface (GUI) or a command line interface (CLI). The stations 320 and 330 may also include a network-enabled appliance such as a tablet, WebTV™ unit, a radio-enabled Palm™ Pilot or similar unit, a set-top box, a browser-equipped or other network-enabled cellular telephone, or another TCP/IP client or other device.

Communications network 310 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection. Communications network 310 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Bluetooth radio link, or an IEEE 802.11-based radio frequency link. Communications network 310 may further comprise, include or interface to any one or more of an RS-232 serial connection, an IEEE 1394 (FireWire) connection, a Fibre Channel connection, an infrared (IrDA) port, a Small Computer Systems Interface (SCSI) connection, a Universal Serial Bus (USB) connection or another wired or wireless, digital or analog interface or connection.

Communications network 310 may be used by a user of the stations 320, as well as the Real Property Income Based Loan administration center 340, for example, to transmit or receive data or information relating to the issuance, purchasing, processing and monitoring of Real Property Income Based Loans in accordance with one embodiment of the invention described herein. For instance, a borrower may electronically submit information to an issuer of a Real Property Income Based Loan in connection with obtaining a Real Property Income Based Loan, for example. The Real Property Income Based Loan administration center 340 may use communications network 310 to transmit periodic reports to owners with a Real Property Income Based Loan, interface with various external systems in connection with the various features and functionality described herein, or to process payments made in connection with Real Property Income Based Loans, for example. Other uses of communications network 310 are of course possible.

FIG. 23 illustrates exemplary modules that may be included in (or associated with) the Real Property Income Based Loan administration center 340 for carrying out (or administering) the various functions and features of embodiments described herein. In some embodiments, the Real Property Income Based Loan administration center 340 may include a property condition assessment module 341, an underwriting processing module 342, a Real Property Income Based Loan processing module 343, an external systems interaction module 344, a document production module 345, a property value determination module 346, a property rental value determination module 347, an interest rate determination module 348, a Real Property Income Based Loan pay-off module 349, and a reporting module 350. Other modules for performing the various features and functionality of the systems and methods described herein may be provided. While the modules may not be used in all embodiments to perform some or all of the functions of the present invention, they are nonetheless presented as possible embodiments.

Property condition assessment module 341 may, in some embodiments, perform various property assessment processes associated with verifying the physical description of the lot and structures plus the overall condition of the property that is the subject of the Real Property Income Based Loan. Module data inputs will include, but are not limited to, size of lot, size of structures, description of structures (number of stories, ceiling heights, type of foundation, type of flooring, number of bedrooms and bathrooms, garage spaces, out buildings, roof types, type of windows, etc.) condition and age of systems like furnaces, water heaters, plumbing, roof, and electrical systems. Inputs may further include an assessment of the overall repairs needed to be performed immediately to make the property rentable and a schedule of future repairs that will need to be performed to maintain the property. In an embodiment, data from module 341 will feed data into the property value determination module 346, then underwriting processing module 342, and the property rental value determination module 347.

Underwriting processing module 342 may, in some embodiments, perform various underwriting processing, including risk assessment, in conjunction with issuing the Real Property Income Based Loan. For example, the underwriting processing module 342 may be provided to analyze the loan to property value ratio and the monthly operating costs versus rental income analysis; these determine whether the property qualifies for the desired loan. For example, it may be that the rental income is insufficient to cover the monthly loan payment plus the other property operating costs. The underwriting processing module 342, in general, may provide the underwriting guidelines under which the Real Property Income Based Loan may be approved.

Real Property Income Based Loan processing module 343 may, in some embodiments, provide the non-risk based processing associated with providing the Real Property Income Based Loan. Such processing may work under the guidelines provided by the underwriting processing module 342. For example, the Real Property Income Based Loan processing module 343 may calculate various parameters of the Real Property Income Based Loan, such as the mortgage payment amount.

External systems interaction module 344 may, in some embodiments, interact or communicate with various external systems, including the stations 320 and 330, proprietary record-keeping systems, non-proprietary record-keeping systems, or any other system. For example, an administrator of Real Property Income Based Loan administration center 340 may provide loan-related information to the reporting systems of banks or other financial institutions. In some embodiments, external systems interaction module 344 may also receive data or information that is electronically submitted by such external rule or regulatory system(s). In this way, the various features and functionality described herein can cooperate with the various systems and methods of various financial institutions in providing services and products to consumers.

The document production module 345 may, in some embodiments, provide the set of documents for closing the Real Property Income Based Loan. That is, based on the various parameters associated with a particular Real Property Income Based Loan, the document production module 345 would generate a suitable set of documents to affect the Real Property Income Based Loan. In an embodiment, the documents produced would serve to contractually bind the lender and borrower to the agreed upon loan terms.

The property value determination module 346 shall, in some embodiments, be provided to determine the fair market sale value of the property that is the basis of the loan should the repairs in the property condition assessment module 341 be completed.

The property rental value determination module 347 shall, in some embodiments, be provided to determine the market rental value of the property that is the basis of the loan should the repairs in the property condition assessment module 341 be completed.

The interest rate determination module 348 may, in some embodiments, monitor the interest rates offered by other major lending institutions regarding loans collateralized by real property of differing amounts, types of property, and life of the loan. In some embodiments, the module will process different risk parameters to calculate the interest rate that will apply to the borrower's loan. This may include, but is not limited to, inputs from the underwriting process module 342 to assess risk factors. For example, if the Real Property Income Based Loan has a high loan to value ratio, then the interest rate charged on the loan will be higher.

The Real Property Income Based Loan pay-off module 349 may, in some embodiments, be provided to calculate the pay-off amount of the Real Property Income Based Loan. That is, if the borrower decides to either sell or to occupy the property, the Real Property Income Based Loan pay-off module 349 would determine the amount due to settle the Real Property Income Based Loan, e.g., based on the loan balance, secured value and resulting collectable proceeds amount.

Reporting module 350 may, in some embodiments, report particulars about the various features and functionality described herein to customers, borrowers, Real Property Income Based Loan administration center 340 administrators and other persons or entities. For example, reporting module 350 may provide a customer with particulars on the Real Property Income Based Loan schedule, value of the property, equity in the property, rent values, property operating costs, or any other data or information that may be relevant to an interested party.

As described above, the drawings show various embodiments of the system of the invention. In particular, FIGS. 4-21 show various steps of embodiments of the invention and FIGS. 22 and 23 show an illustrative system. In addition to the various computer implementation aspects described above, hereinafter, further aspects of contemplated implementation will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processors and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, two memory portions, as described above, may perform the memory storage performed by one distinct memory portion.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any devices that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

In conclusion, today, an unmet need exists for borrowers, and in particular senior borrowers, in affording them the opportunity to be able to move out of their primary residence and still maintain ownership of the property. This need often extends to many people of varying age groups that find themselves in need of money, but for various reasons such as poor credit, insufficient income, or lack of property management experience, they cannot obtain an affordable loan through conventional lenders. This present innovation will help both senior borrowers with reverse mortgages and other borrowers, regardless of age, obtain a loan and keep ownership of any real property that can generate sufficient income as a rental.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

### EXAMPLES

### Example #1

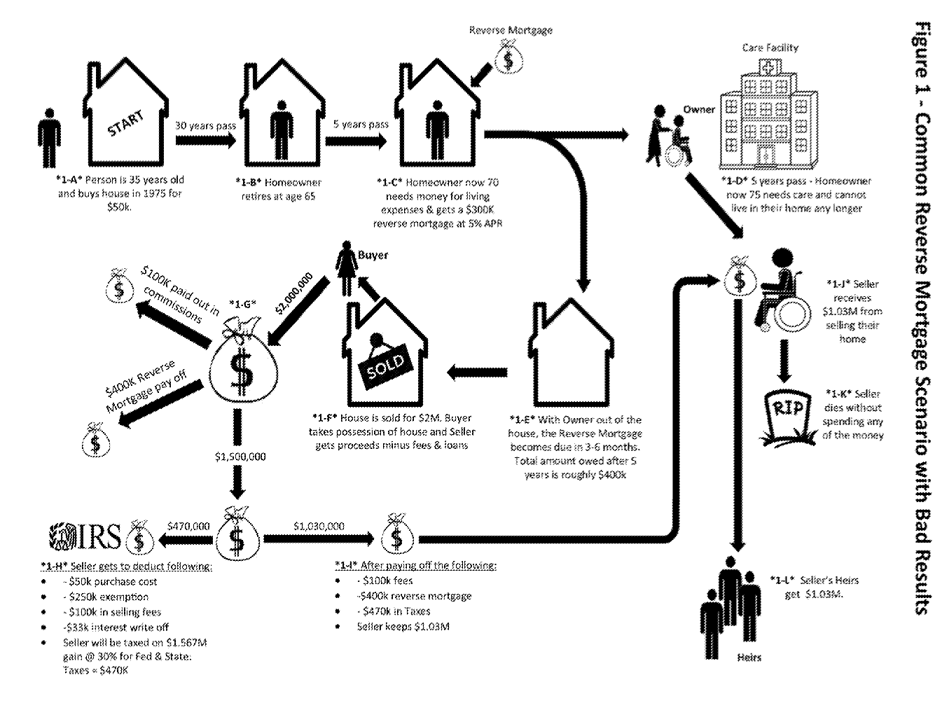

### FIG. 1: Common Reverse Mortgage Pitfall

This example entails the common pitfall that occurs when a senior citizen has obtained a reverse mortgage and then find themselves needing to move out of their home. In the San Francisco Bay Area, at the time this was written, the numbers applied to this example are very realistic. All steps in this example refer to the diagram in FIG. 1.

Per step 1-A, imagine a person buys a house in 1975 at a cost of $50,000. They are still living in the house 30 years later when they reach the retirement age of 65 (step 1-B). They remain living in their home for another five years making the owner 70 years old. With their retirement funds dwindling, the owner decides to get a reverse mortgage (step 1-C). The reverse mortgage pays out $300,000 to the owner and interest begins to accrue at a 5.0% annual rate, compounded monthly.

Another 5 years pass and the owner is now 75 and his failing health demands that he moves out of his home and into a care facility (step 1-D). This leaves his home vacant (step 1-E), which triggers the need for the reverse mortgage to be fully repaid within 3-6 months. The interest that accrued over 5 years on the mortgage results in a $400,000 balance owed on the loan. The owner lacks the funds to repay the loan, so he decides to sell the house. Herein, the owner may also be referred to as the “seller.”

The house is put on the market and it sells for $2,000,000 (step 1-F). A buyer brings in the money, receives title to the house, and the seller nets out about $1,500,000 (step 1-G). This is because the seller will need to pay out about 5% in real estate commissions ($100,000) and of course repay the $400,000 reverse mortgage.

| | |
|---|---|
| Property Sale Price | +$2,000,000 |
| Real Estate Commissions | −$100,000 |
| Pay off Reverse Mortgage | −$400,000 |
| Net Proceeds before Taxes | +$1,500,000 |

Now tax time rolls around and the seller also needs to pay long-term capital gain taxes (step 1-H). The seller had a purchase price basis of $50,000 (what he originally paid for the property), he gets to deduct the real estate commissions and a few other fees ($100,000), plus he gets a $250,000 tax exemption for his personal residence. He also gets to deduct part of the interest charged on the reverse mortgage, but only the interest charged on $100,000 of the mortgage, the remainder of the interest cannot be deducted. The IRS only allows deductions on the first $100,000 borrowed. Reverse mortgages are considered to be like a home equity line of credit and the current tax rules limit interest deductions to the first $100,000. So, the seller will only be able to deduct approximately $33,000 in interest. With the deductions, the seller will be taxed on a $1,567,000 profit.

| | |
|---|---|
| Property Sales Price | +$2,000,000 |
| Real Estate Selling Fees | −$100,000 |
| Property Purchase Price | −$50,000 |
| Tax Exemption | −$250,000 |
| Reverse Mortgage Interest | −$33,000 |
| Taxable Income | +$1,567,000 |

In California, at the time this was written, the total long-term capital gain taxes are about 30% (Fed and State combined). This means that the seller will pay out about $470,000 in taxes (30% of $1,567,000), which leaves him with approximately $1,030,000 after taxes (steps 1-I and 1-J).

| | |
|---|---|
| Property Sales Price | +$2,000,000 |
| Real Estate Selling Fees | −$100,000 |
| Reverse Mortgage Pay off | −$400,000 |
| Taxes | −$470,000 |
| Net Proceeds After Taxes | +$1,030,000 |

So about one third of the estate's value was lost in large part because of the need to pay the long-term capital gains tax on the profit from selling the house. If the seller had desired to maximize the value of the estate he could pass on to his heir(s), then he made a major mistake by selling the house because now he can only pass on the $1,030,000 to his heir(s); assuming he doesn't spend part of it (step 1-L).

This is a simplified example and the savings could be less substantial, especially when it involves married couples, because the tax exemptions can be larger and there can also be a step up basis in the purchase price if one spouse passes away. Furthermore, many other states have lower capital gain tax rates than California. Nonetheless, this simplified example expresses the pitfalls seniors can suffer when they obtain a reverse mortgage and are later forced to sell the property to repay the debt.

### Example #2

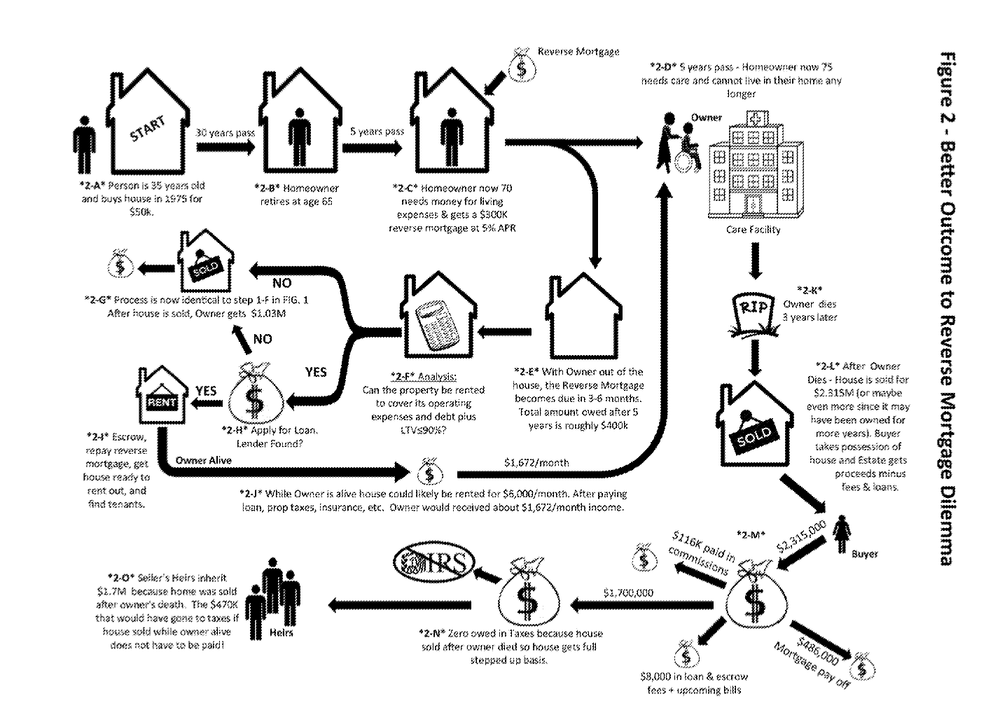

### FIG. 2: Better Outcome to Reverse Mortgage Dilemma

Now assume the exact same scenario occurs as in steps 1-A through 1-E in Example #1-FIG. 1 (same as steps 2-A through 2-E in FIG. 2), but instead of selling the house, as in Example #1, the owner employees the services of a broker offering the present innovation, which then determines that the property could generate sufficient income to pay off the reverse mortgage and any other related debts. The result in that the owner will not have to sell the property. The analysis identified in step 2-F of FIG. 2 entails all the steps in FIGS. 5-17.

Assume like in Example #1, the owner had borrowed $300,000 on their reverse mortgage. A debt search is performed (step 110) and finds no other debts other than the reverse mortgage attached to the property. An assessment of the property's condition is executed (steps 120 and 140) and a decision is made that there is $100,000 in costs related to making the property rentable (step 150). The balance owed on the reverse mortgage is $400,000; just like in Example #1. Additionally, should a loan be provided to the owner, there will be approximately $5,000 in fees related to loan processing plus title and escrow fees. Finally, there are about $3,000 in operating expenses that will need to be paid prior to the property generating income. In total, the owner will need to borrow $508,000 to be able to pay off debts and get the house rented out.

| | |
|---|---|
| Repay Reserve Mortgage | +$400,000 |
| Repairs/Upgrades | +$100,000 |
| Loan/Title/Escrow Fees | +$5,000 |
| Operating Expenses | +$3,000 |
| Total Loan Amount | +$508,000 |

A title search of the owner's property is performed, which verifies that the client is the legal owner and the planning/permit records describe fairly accurately the property as it currently exists (steps 110 and 120). A rental analysis is performed and it is determined that after the $100,000 in upgrades/repairs are completed, the house could rent for $6,000 per month (step 130). Then a value analysis is performed and it is determined that after the $100,000 in upgrades/repairs is completed, the house could sell for $2,000,000 (step 130).

A loan to value analysis is performed (loan÷value=$508,000÷$2,000,000=0.25) and the result is a 25% loan to property value ratio, which is a very low risk ratio (step 180). Then based on other parameters, an interest rate of 5.5% is calculated for the loan (step 190). Using the formula in step 200, the monthly payment for a $508,000 loan at an annual rate of 5.5%, amortized over 30 years, is $2,885.

Then the monthly operating expenses need to be calculated (step 160). These might look something like the accounting below:

| | |
|---|---|
| Property Taxes ($3,000/year) | −$250 |
| Insurance ($1,500/year) | −$120 |
| Property Management (5%) | −$300 |
| Gardener | −$200 |
| Utilities paid by owner | −$200 |
| Monthly Operating Expenses | +$1,070 |

From step 143 other issues with the property are identified that do not require immediate repair, but will likely need to be repaired or replaced within the next 5 years (step 210). Assume these items tally up to $22,500. Then we add 10% to this estimate to account for cost overruns, which results in $25,000. When prorated over 5 years, this results in needing to save $417 per month for maintenance reserves.

Next, the total monthly ownership costs are calculated to keep the property (step 220) and compared to 95% of the monthly rent. So, the total monthly costs are:

| | |
|---|---|
| Mortgage Payment | $2,885 |
| Operating Expenses | $1,070 |
| Savings for Reserves | $417 |
| Monthly Operating Expenses | $4,372 |

The $6,000 monthly rent is then multiple by 0.95 (vacancy factor of 5%) and the resulting pro forma rent is $5,700 per month. The monthly rent is well above the monthly ownership costs of $4,372. This means that the owner's property is qualified for the $508,000 loan. It also means that the owner could keep his property and receive up to $1,672 per month in cash flow from the property.

Per step 2-H in FIG. 2, should the owner decide to secure the loan to keep his property, then he would fill out some loan application paperwork, the loan reports listed in step 231 would be compiled, and sent out to investors. If an investor cannot be found to loan the funds, then the property must be sold per step 2-G. If investors are interested in making the loan, then the process moves to step 2-I.

Per step 2-I in FIG. 2, once the loan is approved and a willing investor identified, escrow would be opened and the funds from the lender(s) are deposited into an escrow account. The reverse mortgage would be paid off from the escrow account, a reconveyance would be issued, followed by a new promissory note and foreclosure instruments (either a Deed of Trust of Mortgage) created in favor of the lender, which would be recorded in the local county (step 230). After the funds are available, work would then commence to make the necessary repairs/upgrades to the property to make it ready to be rented out. Then professional property management would be hired to advertise and show the rental, take potential tenant applications, sign a lease, withhold deposits, and allow the tenant to move in.

For the period where the owner is still living (step 2-J in FIG. 2), the net proceeds of $1,672 from the rent are sent to the owner.

Assume this goes on for three years and then the owner dies (step 2-K in FIG. 2). It is reasonable to assume that the property was appreciating 5% annually over the three years. The property would now be worth about $2,315,000. Further assume that the heir(s) simply want to sell the property almost immediately after the owner's death (step 2-L). The original $508,000 loan balance has been paid down to $486,000 over the three years. The real estate commission fees of 5% equal $116,000 and there would some escrow/title fees to also be paid (step 2-M).

| | |
|---|---|
| Sale Price of Property | +2,315,000 |
| Repay Mortgage | −$486,000 |
| Commission Fees | −$116,000 |
| Title/Escrow Fees | −$7,000 |
| Net Proceeds to Heir(s) | +$1,706,000 |

Capital gains taxes do not need to be part of this calculation. At the time this was written, there is a tax exemption for estates worth less than $5,430,000. So, the heir(s) inherit the house without having to pay estate taxes should the entire estate be worth less than $5,430,000. The heir(s) also get a step up basis in the price for the property at the time of the owner's death. This means that the property is treated as if the heir(s) paid $2,315,000 for it. So, when they sell it for $2,315,000, it is as if there was no profit made on the sale, thus no capital gains taxes need to be paid. The heir(s) receive $1,706,000 as compared to the $1,030,000 they would have gotten if the property had instead been sold when the owner moved out of his house (steps 2-N and 2-O).

The conclusion from example #2 is that by the owner taking advantage of the loan in the present invention, he was able to move out of his home and receive the care he needed plus he was able to keep the property. This allowed the owner to benefit from its appreciation in value, to enjoy a monthly income of $1,672, and was also able to pass down an estate worth nearly $700,000 more to his heir(s).

### Example #3

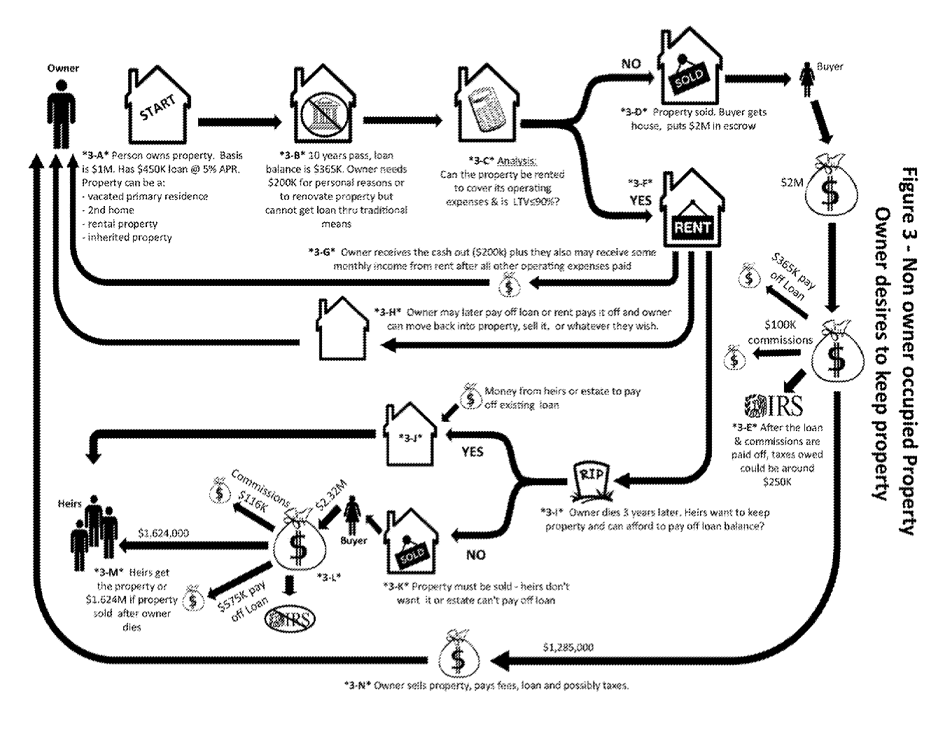

### FIG. 3: Applying the Present Invention to Something other than a Reverse Mortgage

An embodiment of the present invention could also serve the owner of any real property (commercial, residential, or multi-unit), that is either non-owner occupied or soon to be non-owner occupied and needs funding for various purposes, including, but not limited to, paying off debts attached to the property (such as mortgages or liens), improvements to the property, or other financial needs unrelated to the real property. Perhaps the owner either has poor credit, insufficient personal income, or lack of property management skills (this can be a consideration for some lenders), which prevents the owner from being able to qualify for a loan through major institutions at a reasonable cost.

The same methods used to finance an elderly owner with a reverse mortgage in FIG. 2 can be applied to a real property owner of any legal age, that owns any kind of real property, that has the potential to be rented out and could be sold if a foreclosure was necessary.

In the example in FIG. 3, assume that a person buys a property for $1,000,000 and finances $450,000 at 5% APR (step 3-A). Assume that 10 years later that the property is worth $2,000,000 and the balance owed on the loan is now $365,000. Further, assume that this property owner finds himself in desperate need of approximately $200,000 and for the various reasons previously mentioned, the owner cannot secure affordable financing (see step 3-B). Here too, this owner's real property will go through the same analysis as was previously performed for the elderly owner (see step 3-C). So, if the property's title checks out, the physical property matches the permit records, the loan to value ratio is acceptable, and the monthly income from rent is sufficient to service the debt and pay the operating costs plus reserves, then the owner should be able to secure financing through our innovative process (see step 3-F). Just as in Example #2, the lender(s) will carry a promissory note on the property while the owner retains title. The property is then rented out (if it is not already tenant occupied) and property management services will supervise the property as a rental (step 3-G in FIG. 3).

Financing through this innovative process offers a twofold benefit to the owner. First, he avoids paying around $250,000 in capital gains taxes were the property sold (step 3-E in FIG. 3). Second, the owner is also able to obtain the $200,000 cash he desperately needed. Additional benefits include the potential for future appreciation in the property's value, possible cash flow from the rent, and the option of passing the property down to heir(s).

Should the owner in FIG. 3 desire to maximize the estate he passes on to his heirs, then selling would have been a mistake. Were the owner to sell the property when he needed the money, then the math would look something like the following (steps 3-E and 3-N in FIG. 3):

| | |
|---|---|
| Sale Price of Property | +2,000,000 |
| Repay Mortgage | −$365,000 |
| Commission Fee | −$100,000 |
| Taxes | −$250,000 |
| Owner's Need for cash | −$200,000 |
| Net Proceeds to Heir(s) | +$1,085,000 |

Thus, the result is that the property owner would only pass approximately $1,100,000 to his heirs should he sell the property when he needed the money. If the owner was instead able to obtain the financing he needed to get the $200,000 cash out and then died 3 years later, then the math could look like the following were the property sold after the owner's death steps 3-K, 3-L and 3-M in FIG. 3):

| | |
|---|---|
| Sale Price of Property | +2,315,000 |
| Repay Mortgage | −$575,000 |
| Commission Fee | −$116,000 |
| Taxes | −$0 |
| Owner's Need for cash | −$0 |
| Net Proceeds to Heir(s) | +$1,624,000 |

Here too, it is assumed that the property appreciated in value 5% per year over the three years after the owner refinanced. The loan shown above is larger because it covers both paying off the old loan and providing the owner the $200,000 cash he needed. Finally, there are no taxes to be paid if the value of the owner's estate was below $5,430,000 at this time this was written. The conclusion is that the owner was able to pass down an estate worth about $500,000 more to his heirs by not selling the property when he needed money.

What is claimed is:

1. A method to finance real property that a borrower already owns, which is either already or soon will be rented out to someone other than the borrower or anyone on title to the property, wherein the property's actual or potential rental income is used for loan qualification decisions instead of using the borrower's personal income in conjunction with services, the method comprising:
determining whether borrower is legally authorized to encumber the property;
determining the existence and amount of any debts or liens attached to the property;
determining the condition of the property and assess the necessity for any short and long-term repairs plus and the associated costs and time to complete said repairs;
determining the repaired rental value of the property;
determining the repaired sale value of the property;
determining the costs associated with ownership of the property, initially excluding monthly mortgage payments;
establishing the total funds said borrower needs to finance, funds comprise of monies to:
pay off any existing debts or liens against the property,
perform necessary repairs to the property,
fund operating costs until the property is economically self-sustaining, and
pay title, escrow, and loan fees associated with the loan;
determining whether the loan to value [LTV] ratio of the property exceeds the ratio acceptable to lenders;
establishing the financing interest rate using multiple factors comprising of:
current market interest rates for properties in same category as said property,
LTV ratio of the property, and
short and long-term local real estate market trends for properties in the same category as said property;
establishing the total monthly operating costs associated with ownership of the property, including payments allocated towards the monthly mortgage, prorated insurance and property taxes, utilities, property services such as gardeners and property management, savings allocated to long term repairs, and any other costs;
determining whether the property is qualified for financing based on the repaired rental value being greater than the total monthly operating costs;
wherein the property is qualified for financing based on its income versus operating costs ratio (the rental income generated exceeds the property's total monthly operating costs) and an acceptable LTV ratio, then the following actions shall be performed:
an investment report shall be compiled and disseminated to investors best suited for the loan sought, the report shall describe the property, the amount sought to be financed and how the funds are to be distributed, the LTV ratio, the market value of the property, the rental value of the property, and any other information deemed material by the arranger of credit;
an investor shall be selected to finance the loan, wherein multiple investors are interested, then the one offering the most favorable terms to the borrower shall be selected;
open escrow and verifying that the lender transfers full funds into the escrow account;
verifying that escrow has generated a promissory note and right to foreclosure documents regarding the property in favor of said lender;
verifying escrow pays off all debts and liens attached to the property that the arranger of credit deems necessary and reconveyances are generated and recorded; and
verifying that any excess funds reserved for repairs, initial operating costs or for any other purpose are distributed to the appropriate parties;

2. The method of claim 1, wherein the borrower also receives a cash payout that is included as part of the amount financed.

3. The method of claim 1, wherein the monthly operating costs shall include a minimum agreed upon monthly stipend to be paid to the borrower during the life of the loan.

4. The method of claim 1, wherein the borrower and anyone else on title to the property must provide the arranger of credit copies of all tax filings for the past two years as a condition of financing.

5. The method of claim 1, wherein a licensed appraiser assesses the property's fair market sale and rental value.

6. The method of claim 1, wherein any of the arrangers of credit comprise of a mortgage broker, a business loan broker, a direct mortgage lender, a private party, or a real estate broker.

7. The method of claim 1, wherein a professional service is employed to generate the loan documents comprising of contracts and various disclosures for the lender and borrower sign.

8. The method of claim 1, wherein professional property management services are employed as part of the financing agreement to take actions comprising of:
leasing out the property when needed;
collecting rents;
maintaining the property;
maintain rental accounting records comprising of income and expenses plus furnishing tax documents when necessary to all appropriate parties; and
distributing rental proceeds to appropriate parties.

9. The method of claim 1, wherein professional loan management services are employed as part of the financing agreement to:
collect monies from property manager;
pay lender monthly mortgage amount owed from monies collected;
maintain accounting records of the loan payments received comprising of interest and principal and those paid to lender in addition to maintaining the loan balance owed lender;
generate and distribute tax documents when necessary to all appropriate parties; and
continue providing these services until the loan balance is fully repaid, at which time a reconveyance shall be recorded with the local county.

10. The method of claim 1, wherein the employed professional loan servicing entity in claim 9 shall monitor whether the borrower, or anyone on title to the property, does not breach nor trigger any term of the financing agreement that demands an immediate repayment of the loan balance owed, including that:
neither borrower nor anyone on title shall encumber the property with liens superior to lender's own lien during the entire period that the financing is not fully repaid;
the property shall remain a rental during the entire period that the financing is not fully repaid;
neither the borrower, nor anyone on title to the property shall be a resident or tenant at the property during the entire period that the financing is not fully repaid;
the property shall always be professionally managed, neither borrower nor anyone on title to the property may manage the property during the entire period that the financing is not fully repaid; and
the borrower must remain alive during the entire period that the financing is not fully repaid.

11. The method of claim 1, wherein the arranger of credit sells the property for the borrower or his heir(s) should either they voluntarily decide to sell the property or should the property have to be sold due to borrower or his heir(s) triggering an acceleration pay off clause and they are unable to repay the full loan balance owed.

12. The method of claim 1, where the arranger of credit also provides any one or all of the services listed in claims 7-11.

13. The method of claim 1, wherein a computing apparatus is employed to implement and manage the services, the computing apparatus comprising:
a computing device, including:
an input device configured to receive input; and
a display device configured to display data including property information reports, real property sales data, real property rental data, and loan pricing data;
a database, or access to external databases, that include the following information:
whom has legal title to the real property and descriptions of any recorded debts, liens, encumbrances, and/or easements attached to the property;
local rent ordinances that may impede evictions or the ability to raise rents;
the permit history of the property and legal description of any land or structures associated with the property;
property information generated by inspectors, contractors and the arranger of credit, including physical descriptions of the property and any inspection results with the data organized into the repairs that need to be completed prior to renting out the property (itemized by their associated costs and estimated time to complete such tasks) versus the repairs that need to be completed within five years after renting out the property;
operating costs related to ownership of the property including monthly prorated property tax and insurance costs;
escrow and title fees for different loan amounts and types of real property;
real property data pertaining to majority of homes either sold or offered for sale in the region of said real property;
real property data pertaining to majority of homes either rented out or offered for rent in the region of said real property;
loan data such as interest rates, points, and fees from multiple large nationally recognized lenders offering loans for the same property category; and
list of lenders willing to finance the type loan in the present invention and the specific individual loan terms preferred by each individual lender.
a processor; the processor configured to process data, including to:
receive, from the computing device, a request for a real property loan on a specified property by a specified borrower;
retrieve, from the database, the names of people or entities on title to the property;
output, including to the computing device and display device, whether the borrower's identification matches that of the person named on title to the property being financed;
retrieve, from the database, whether there are any restrictive rental ordinances that could impede the ability to receive fair market rent from the property or evict tenants;
retrieve, from the database, the physical description of the property from the visual inspections and from government records;
output, including to the computing device and display device, the physical description of the property from both the visual inspection results and those from the government records and allow arranger of credit to flag which property characteristics will be used for financing purposes;
retrieve, from the database, debts, liens, or other encumbrances attached to the property;
output, including to the computing device and display device, the list of all debts, liens, or other encumbrances attached to the property, allow the arranger of credit to flag which items must be paid and liens against the property released as a condition of the financing, and tally the flagged items;
retrieve, from the database, the itemized of repairs that need to be performed prior to renting out the property, their associated costs, and the time estimates to complete the repairs;
output, including to the computing device and display device, the itemized list of repairs that need to be performed prior to renting out the property and their associated costs, the time estimates to complete the repair tasks, and tally the list;
retrieve, from the database, the property's fair market sale value based on recent comparable sales that most resemble the characteristics flagged by the arranger of credit including, but not limited to, type of property, size of the structures, condition of the property, architectural style, size of the lot, topography of the lot, proximity to said property, proximity to nuisances, desirable amenities like good schools, and any other factors deemed material to the property's value by the arranger of credit;
output, including to the computing device and display device, the list of the comparable and derive a fair market sale value for the property being financed;
retrieve, from the database, a fair rental value based on recent rentals that most resemble said property's actual size, type, condition of the property after the immediate repairs are completed, the architectural style, size of the lot, topography of the lot, proximity to said property, proximity to nuisances, desirable amenities like good schools, and any other factors deemed material by the arranger of credit regarding said property's rental value;
output, including to the computing device and display device, a list of the comparable rentals and derive a fair rental value for the property being financed;
output, including to the computing device and display device, a preliminary loan tally #1, which includes all debts and liens that the arranger of credit requires be paid as part of the financing agreement plus the cost to complete all repairs to the property before it can be rented out;
retrieve, from the database, fees associated with generating loan documents, loan processing fees, title fees, notary fees, recording fees, and escrow fees;
retrieve, from the database, the interest rates and fees major lenders are charging for similar types of properties and loan amounts;
output, including to the computing device and display device, the fees associated with processing the loan including generating loan documents, loan processing fees, notary fees, recording fees, and title fees and escrow fees associated with a loan amount equal to that of preliminary loan tally #1;
output, including to the computing device and display device, a preliminary loan tally #2, which is comprised of the tally of all fees associated with processing the loan plus preliminary loan tally #1;
output, including to the computing device and display device, a loan to value [LTV] ratio by dividing the preliminary loan tally #2 by the estimated fair market sale value of the property.
retrieve, from the database, both short term and long term real estate market value trends in the region;
output, including to the computing device and display device, the preliminary interest rate to be charged for financing preliminary loan tally #2, which is calculated from factors comprising of the interest rates major lenders are charging for equivalent size loans, the LTV ratio, short and long-term regional real estate value trends, and any other factors deemed materials by the arranger of credit;
output, including to the computing device and display device, the monthly mortgage payment amount owed based on the preliminary interest rate and preliminary loan tally #2;
calculate the final loan amount to be financed by running multiple iterations of the loan process to derive the final loan amount borrowed that will be sufficient to pay off the repairs, liens, debts, reserves, processing fees, escrow, title and any other necessary fees coupled with adjustments to the interest rate and processing fees to compensate for changes to the loan amount;
output, including to the computing device and display device, the final loan amount to be financed, the monthly mortgage payment associated with the loan, the interested rate, the LTV ratio, costs of immediate repairs, amount of reserves, total loan processing fees, title and escrow fees, and any other costs associated with the loan; and
output, including to the computing device and display device, the total monthly costs associated with ownership of the property including, but not limited to, operating costs (utilities, gardener, prorated property tax and insurance, etc.), mortgage costs, reserve savings requirement for 5-year repairs, and compare this tally to the fair monthly rental value for the property.
output, including to the computing device and display device, whether the property qualified for financing based on the LTV and income to operating costs ratio.
output, including to the computing device and display device, a letter to the borrower regarding the qualification results:
if their property is qualified what will be the terms of the loan, and
if the property is not qualified then provide the reason for the disqualification.

14. The method of claim 7, wherein a computing apparatus is employed to implement the services.

15. The method of claim 8, wherein a computing apparatus is employed to implement the services.

16. The method of claim 9, wherein a computing apparatus is employed to implement the services.

17. The method of claim 10, wherein a computing apparatus is employed to implement the services.

18. The method of claim 13, wherein a licensed appraiser assesses the property's fair market sale and rental value and inputs it into a database instead of the computer apparatus accessing property sales and rental databases coupled with calculating such values for the property being financed.

19. The method of claim 13, wherein the information or database for any necessary qualification data is unavailable then the arranger of credit may manually input the information into the apparatus where it shall be stored a non-transitory computer-readable medium accessible to the apparatus.

20. A non-transitory computer-readable medium in communication with a data apparatus, including a geographically distributed computing network, the non-transitory computer-readable medium including an executable software code stored thereon, the code including instructions for causing a computer to perform all the necessary processing steps and calculations in claim 13.
